(19) United States
(12) Patent Application Publication
(10) Pub. No.: US 2026/0220655 A1
(43) Pub. Date: Jul. 30, 2026

(54) Artificial Intelligence (AI) based Estimation System for Entertainment Industry Projects

(71) Applicant: William Roetzheim, Jamul, CA (US)

(72) Inventor: William Roetzheim, Jamul, CA (US)

(21) Appl. No.: 18/737,874

(22) Filed: Jun. 7, 2024

(51) Int. Cl. G06Q 30/0202

(52) U.S. Cl. CPC G06Q 30/0202

(57) ABSTRACT

The present invention discloses an artificial intelligence-based computer application used for preparing budgets, forecasting revenue, and preparing investor financial analysis waterfalls for entertainment industry projects, including films. The system utilizes attributes of a potential project as independent inputs and applies computer modeling techniques for generating dependent outputs. The dependent outputs include budget breakdowns, production schedules, revenue forecasts, cash flow analysis, and investor waterfalls for the modeled project.

### FIELD OF THE INVENTION

The present invention relates to a software system for estimating values for entertainment industry projects that operates on a computer system. More particularly, the present invention relates to an artificial intelligence-based estimation system for entertainment industry projects.

### BACKGROUND OF THE INVENTION

Film and television projects are complex endeavors, requiring significant financial and human resources. The current methods for budgeting, revenue forecasting, and financial analysis are largely manual, relying heavily on industry expertise. This approach is not only cumbersome and prone to errors, but also hinders the ability to iteratively optimize and refine projections by adjusting specific input assumptions. Furthermore, these processes are typically deterministic, using average or expected values, which overlooks the importance of probabilistic outcomes and associated risks in a volatile industry like entertainment.

An expert system that can prepare budgets, forecast revenue, and prepare investor financial analysis waterfalls with approximately the quality of those forecasts prepared by human experts offers value in terms of improved consistency and the speed with which the forecasts can be prepared. Improved consistency then facilitates adaptive learning and improvement because deviations between forecast and observed actuals can be statistically analyzed without the variabilities inherent in the informal, human expert based expert opinion-based estimating. Improvements in the speed of preparing the forecasts versus human experts makes iterative optimization feasible, because dozens, hundreds, or even thousands of forecasts can be realistically prepared under a variety of input assumptions.

Current forecasting typically treats the project characteristics including casting; the project budget; the project revenue forecasts; and the project financial analysis waterfalls as loosely coupled models that are often prepared by separate people working independently. A system dynamic model that integrates and tightly couples these four major areas improves the accuracy of forecasting by automating the process of moving output variables from one model to input variables of another model, and then provides insight into dependencies and interactions between the models that allows system level observation and analysis that may result in observing system behaviors that would be difficult to discover and understand while only looking at the individual components of the system.

Forecasts of budgets, expected revenue, and investor financial analysis waterfalls will never exactly match the observed actual values. Current approaches to adjusting forecasting models relies heavily on learning through experience by the human experts that are preparing the forecasts. This results in a dependency on the skills of those experts, and it is susceptible to various forms of cognitive bias, including confirmation bias, hindsight bias, anchoring bias, misinformation bias, availability bias, and optimism bias. By incorporating parameterized models to prepare these forecasts, then incorporating training feedback loops to support adaptive learning through parameter adjustments, the system will learn from errors, adapt to changing circumstances in the industry, and avoid errors related to human cognitive bias.

Because forecasts of budgets, expected revenue, and investor financial analysis waterfalls are prepared manually, forecasters must simplify their analysis to a set of values that represent the expected or most likely case. At most, manual forecasting allows forecasters to develop a small number of alternate scenarios (typically: expected, best, and worst case.) Because all forecasts are probabilistic, the width and shape of the probability curve around those expected cases contains valuable information from the perspective of understanding and allowing for risk (both threats and opportunities.) A computerized modeling system allows the individual probability curves to be stored for values throughout the system, and these probability curves can then be used to better understand financial risk related threats and opportunities associated with the project.

A US Publication 20030018952 assigned to William Roetzheim discloses an adaptable resource estimating system that operates on a computer system and uses a highly flexible parametric rule to estimate information technology project costs. The parametric rule receives values, including values relating to each of a software project type, a software lifecycle, and a software standard. Responsive to choosing the project type, the lifecycle, and the standard, the adaptable resource estimating system sets values in the parametric rule. The parametric rule executes, and resource estimates are prepared regarding resource utilization for the chosen project type, lifecycle, and standard. Although, the patent discloses the adaptable resource estimating system, the patent fails to disclose anything related to preparing forecasts of budgets, expected revenue, and investor financial analysis waterfalls for projects in the entertainment industry. In addition, it does not an address adaptive and dynamic computer modeling system for doing the same.

Another US Publication 20200396357 assigned to Wemovie Technologies describes a cloud-based production system for making movies and videos, including end-to-end or full-service movie production cloud services from a story to final movie content delivery. The system includes a pre-production subsystem, a production subsystem, and a device management subsystem. The system is configured to receive information about a storyline, cameras, cast, and other assets for the movie from a user to generate one or more machine-readable scripts corresponding to one or more scenes, and further determines constraints among the scenes and to determine actions for the cameras and the cast for obtaining footages according to the storyline. Although, the patent discloses a cloud-based production system for making movies, videos, and video editing, the patent does not disclose anything related to preparing forecasts of budgets, expected revenue, and investor financial analysis waterfalls for projects in the entertainment industry. In addition, it does not an address adaptive and dynamic computer modeling system for doing the same.

Another PCT application WO2022093605 assigned to Sean Douglas Cooney discloses a system for synchronizing entertainment production resource procurement with production project scheduling, aggregating a large number of resources before, during, and after filming. A method of production scheduling that directly connects to real-time accessible marketplace resources (labor, equipment, services) to help producers find and hire the equipment, creative services, and human capital needed to produce a film or other audiovisual media is disclosed. This method helps producers schedule and book the resources they need to produce content. The resources are tied to a smart timeline that synchronizes production schedule changes against available resources. The method also alerts suppliers and producers of any changes to the production timeline. Although, the publication disclosed aggregates the resources before, during, and after filming, the patent does not disclose anything related to preparing forecasts of budgets, expected revenue, and investor financial analysis waterfalls for projects in the entertainment industry. In addition, it does not an address adaptive and dynamic computer modeling system for doing the same.

Although, the prior art describes resource planning software for various projects related to digital media and film making, the resource planning software requires input of the necessary data from the software operator. These data values would currently come from human experts. The current invention covered by this patent represents an alternate approach to creating the input data needed for these production management systems. No existing patent describes an adaptive and dynamic computer modeling system for preparing forecasts of budgets, expected revenue, and investor financial analysis waterfalls for projects in the entertainment industry.

This patent offers valuable and unique capabilities that will significantly improve the ability of the entertainment industry to apply artificial intelligence and other computer modeling techniques to the development of forecasts of budgets, expected revenue, and investor financial analysis waterfalls for projects in the entertainment industry.

### SUMMARY OF THE INVENTION

In accordance with the present invention, the disadvantages and limitations of the prior art are avoided by providing an artificial-intelligence based financial forecasting system for projects in the entertainment industry. The project may be a movie, television series, media, digital media and alike. The system is an artificial intelligence (AI) supported computer modeling application that uses attributes of a potential film or other entertainment project as independent inputs, applies computer modeling techniques including parametric equations, stochastic simulation, rule based expert system modeling, and self-learning, adaptive dynamic modeling, and then generates dependent outputs including budget breakdowns, production schedules, revenue forecasts, cash flow analysis, and investor waterfalls for the modeled film.

At a high-level, the system is grouped into a budget modeling subsystem to generate budget breakdowns and production schedules, a revenue modeling subsystem to generate revenue forecasts and cash flow analysis, and an investment modeling subsystem to generate investor waterfalls. These three modeling subsystems are tightly coupled to interact with each other, in that data flows between the subsystems such that changes in one subsystem affect the other subsystems.

The primary object of the present invention is to improve the ability of the entertainment industry to apply artificial intelligence and other computer modeling techniques to the development of forecasts of budgets, expected revenue, and investor financial analysis waterfalls for projects in the entertainment industry.

Another objective of the present invention is to provide a budget modeling subsystem that forecasts comprehensive budgets that encompass all top-line budget items, including cast salaries, crew wages, equipment rentals, and post-production costs.

In one embodiment of the present invention, the budget modeling subsystem, the revenue modeling subsystem, and the investment modeling subsystem interact with each other, in which the data flows between the subsystems such that the changes in one subsystem affect the other subsystem.

In another embodiment of the present invention, the budget modeling subsystem, the revenue modeling subsystem, and the investment modeling subsystem use adaptive dynamic or self-learning modeling for preparing film industry project forecasts.

In yet another embodiment of the present invention, the budget input, the revenue input, and the investment requirements include a combination of textual input and dropdown lists, further wherein the dropdown lists include film industry specific selection values. The dropdown lists are based on genre, period, and target budget with respect to specific selection values of the entertainment industry project.

In one embodiment of the present invention, the system uses historic project data and the plurality of templates to represent parameterized configuration data that supports learning over time based on adjustment initiated from observed actual values, plus the rules for a rules-based expert system that supports model adjustment based on entertainment industry project specific input data.

In another embodiment of the present invention, the system uses the historic project data to define power function shaping parameters, polynomial equation shaping parameters, budget line-item benchmark data, genre specific adjustment data, and period specific adjustment data.

Other objectives and aspects of the invention will become apparent from the following detailed description, taken in conjunction with the accompanying drawings, which illustrate, by way of example, the features in accordance with embodiments of the invention.

To the accomplishment of the above and related objectives, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in schematic form, and some details of elements may not be shown in the interest of clarity and conciseness.

FIG. 1 illustrates a producer AI's modeling subsystems in accordance with the present invention.

FIG. 2 illustrates an overview of a budget modeling subsystem in accordance with the present invention.

FIG. 3 illustrates an overview of inputs of the budget modeling subsystem in accordance with the present invention.

FIG. 4 illustrates a project related to manual overrides of the budget modeling subsystem in accordance with the present invention.

FIG. 5 illustrates a travel forecast and adjustment capability of the budget modeling subsystem in accordance with the present invention.

FIG. 6 illustrates a budget line item forecast and adjustment capability of the budget modeling subsystem in accordance with the present invention.

FIG. 7 illustrates a Producer AI schedule model outputs in accordance with the present invention.

FIG. 8 illustrates a budget summary output in accordance with the present invention.

FIG. 9 illustrates a budget line item in detail in accordance with the present invention.

FIG. 10 illustrates a summary report script in accordance with the present invention.

FIG. 11 illustrates a revenue forecast sub-system in accordance with the present invention.

FIG. 12 illustrates revenue specific input data in accordance with the present invention.

FIG. 13 illustrates a foreign sales input in accordance with the present invention.

FIG. 14 illustrates a revenue modeling output in accordance with the present invention.

FIG. 15 illustrates a casting assumptions output detail in accordance with the present invention.

FIG. 16 illustrates an investor water-fall sub-system in detail in accordance with the present invention.

FIG. 17 illustrates an investor waterfall input data in detail in accordance with the present invention; and

FIG. 18 illustrates an investor waterfall output data in detail in accordance with the present invention.

### DETAILED DESCRIPTION OF THE INVENTION

The present specification is directed towards multiple embodiments. The following disclosure is provided to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications, and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise,” “include,” “have,” “contain,” and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

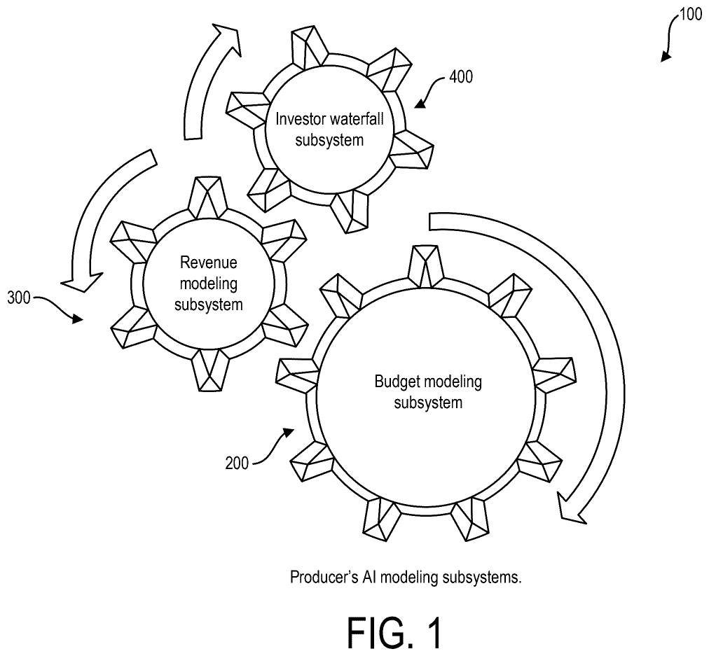

FIG. 1 illustrates an artificial-intelligence based resource estimation system (100) for a project. The system (100) is an artificial intelligence (AI) supported computer modeling application that uses attributes of a potential film as independent inputs, applies computer modeling techniques including parametric equations, stochastic simulation, rule based expert system modeling, and self-learning, adaptive dynamic modeling, and then generates dependent outputs including budget breakdowns, production schedules, revenue forecasts, cash flow analysis, and investor waterfalls for the modeled film.

At a high-level, the system (100) is grouped into a budget modeling subsystem (200) to generate budget breakdowns and production schedules, a revenue modeling subsystem (300) to generate revenue forecasts and cash flow analysis, and an investment modeling subsystem (400) to generate investor waterfalls. As shown in FIG. 1, the budget modeling subsystem (200), the revenue modeling subsystem (300) modeling subsystem and the investment modeling subsystem (400) interact with each other, in a way that data flows between the subsystems occurs such that changes in one subsystem affect the other subsystems.

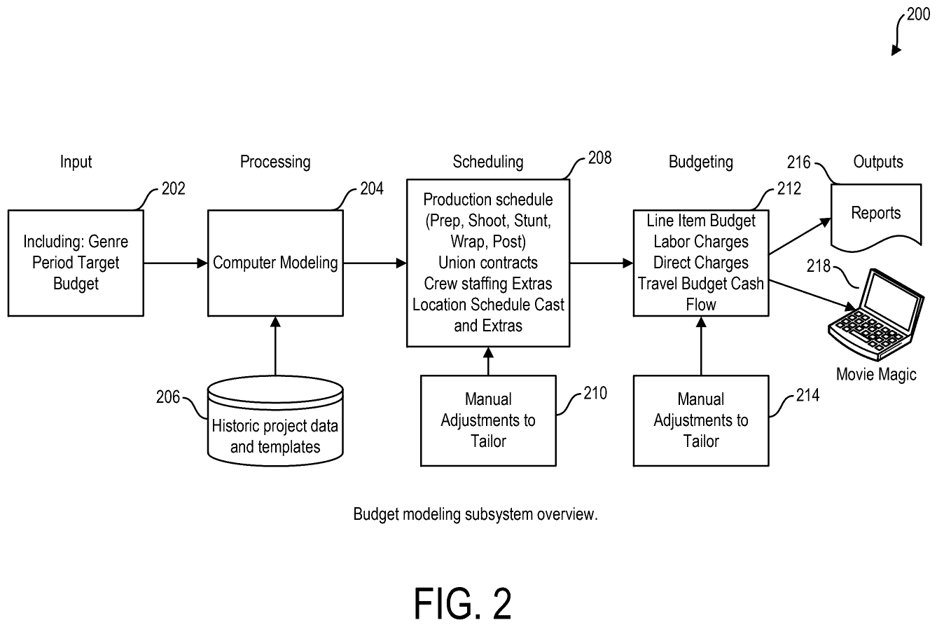

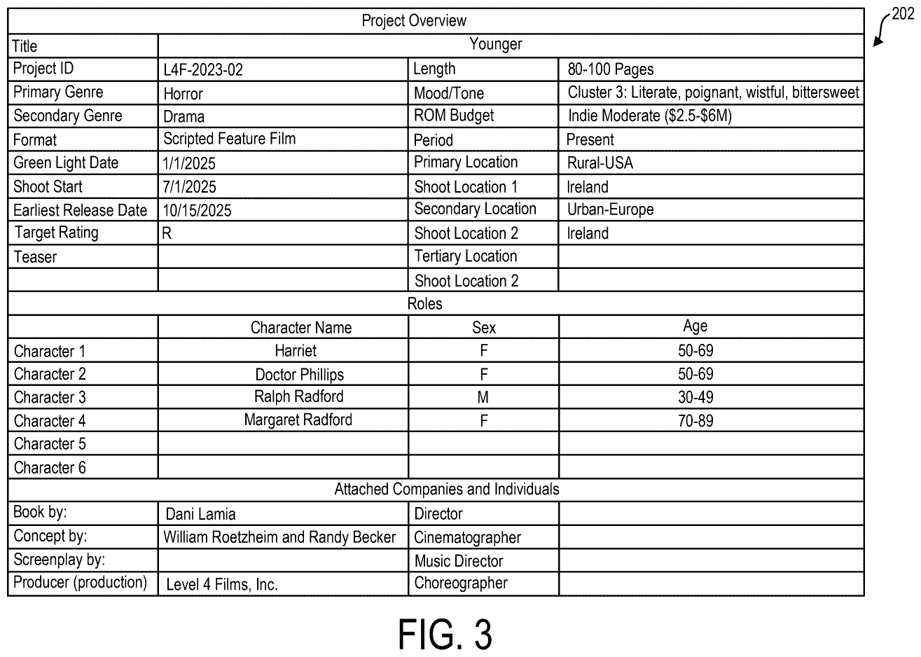

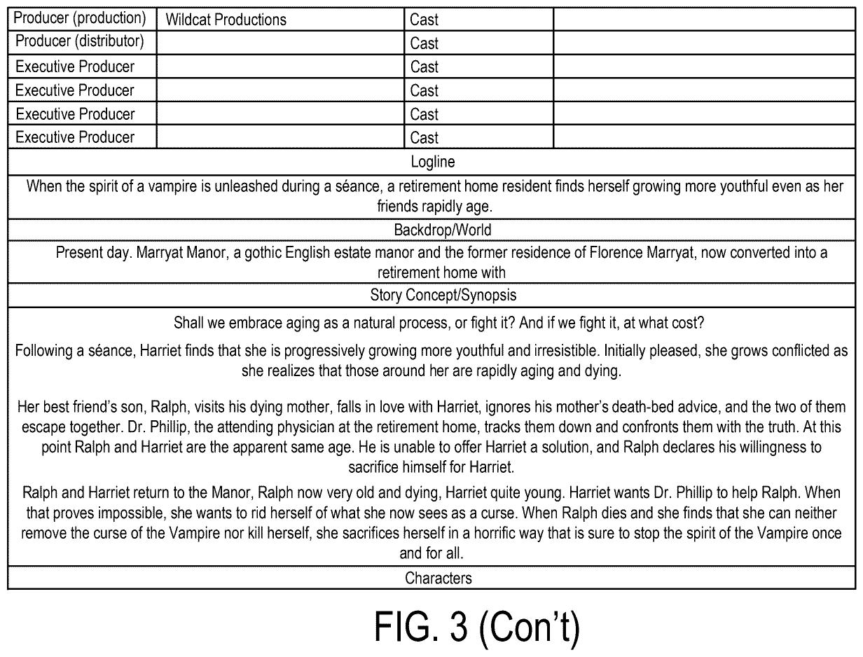

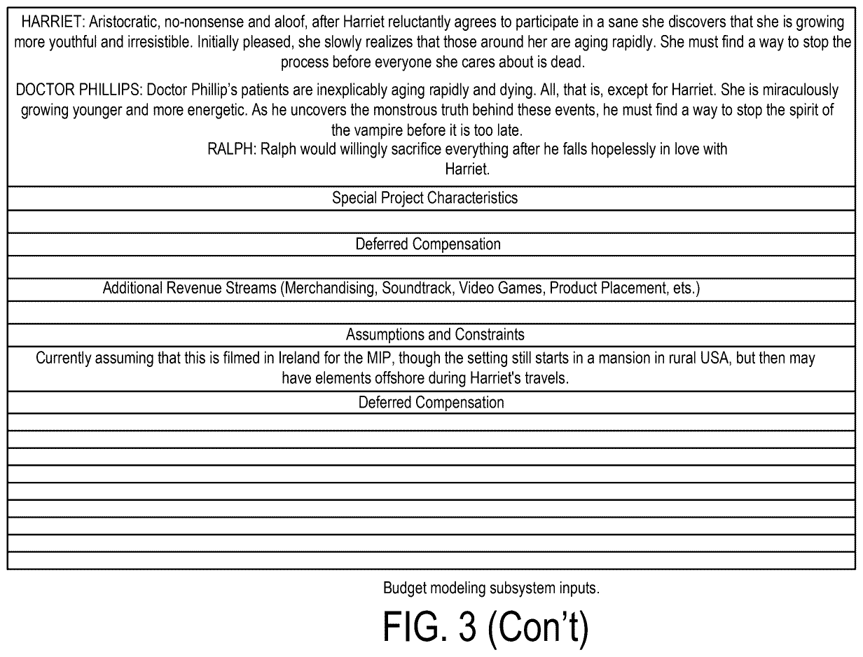

FIG. 2 presents an overview of the budget modeling subsystem (200). The budget modeling sub-system (200) includes a budget input unit (202) for providing input regarding the film project by a user, using an input capability as shown in FIG. 3 in detail. The film specific inputs are then used both by this subsystem and by other subsystems. The user input areas are shown in white. Labels are shown in brown. Input fields include a combination of textual input and dropdown lists where the lists contain film industry specific selection values.

Further, the budget modeling subsystem (200) includes a budget processing unit (204) that is a computer modeling component that is used to generate an optimized film budget based on benchmark data derived from historic project data and templates (206). The historic project data and templates are discussed first, followed by a discussion of the computer modeling components.

The historic project data and templates (206) include historic configuration data that is derived from an analysis of historic (benchmark) projects plus validation using industry experts. The data represents both parameterized configuration data that supports learning over time based on adjustments initiated from observed actuals, plus the rules for a rules-based expert system that supports model adjustments based on film specific input data. The historic data includes power function shaping parameters, polynomial equation shaping parameters, budget line-item benchmark data, genre specific adjustment data, and a period specific adjustment data. Each of the components is discussed individually in detail.

The power function shaping parameters includes power functions that are used to calculate film shoot days. Other equations then use shoot days as inputs to calculate the total film schedule. For very low budget films below a configurable threshold, a step-function is used to determine the number of shoot days. For films outside the range of this step-function, a power function is used to convert between the film budget and the number of shoot days.

The equation used is shown in Equation 1 (Shoot-day calculation), where S is the dependent variable, B is the independent variable, and T_{f}, Ta, and T_{b} are the historic configuration data that is then adapted over time.

$$S = {T}_{f} + {T}_{a} {B}_{m}^{{T}_{b}} \qquad Equation 1$$

$$Shoot - day calculation .$$

Where:
   S=Shoot days.
   T_{f}=Power function constant.
   Tₐ=Coefficient, representing default days per $M budget.
   Bₘ=Film budget in millions of dollars.
   T_{b}=Exponent, representing economies and diseconomies of scale.

The polynomial equation shaping parameters include other-direct-charges (ODCs) that are divided into fixed ODCs, covered elsewhere, and variable ODCs. Variable ODCs are computed using the polynomial equation from Equation 2 (Variable ODC calculation), where the four polynomial coefficients are derived empirically based on historic film data. These parameters are adapted over time to maintain accuracy.

$${ODC}_{v} = {O}_{1} + {O}_{2} {B}^{1} + {O}_{3} {B}^{2} + {O}_{4} {B}^{3}$$

Where:
   ODCᵥ=Variable ODCs.
   O₁ through O₄ are polynomial coefficients.
   B The film target budget.

The budget line-item benchmark data includes the film's budget line-item baseline that is computed using budget line-item benchmark data. Each budget line-item is described using the following configuration data: Category: Budget category, as in Above the Line; Production; Post-Production; and General and Administrative (G&A); Budget Line: The budget accounting code, which may map to production software such as Movie Magic; Description: A description of this budget line item; Fixed Price ODCs: The fixed amount of ODCs that should be budgeted for this line item, in addition to any other budget amounts; Variable ODC percentage: The percentage of the variable ODCs that should be allocated to this line item; Labor percentage: The percentage of film labor that should be allocated to this line item; Category: Budget category, as in Above the Line; Production; Post-Production; and General and Administrative (G&A); Budget Line: The budget accounting code, which may map to production software such as Movie Magic; Description: A description of this budget line item; Fixed Price ODCs: The fixed amount of ODCs that should be budgeted for this line item, in addition to any other budget amounts; Variable ODC percentage: The percentage of the variable ODCs that should be allocated to this line item; Labor percentage: The percentage of film labor that should be allocated to this line item. Labor allocation: The labor contract allocation associated with this line item. For example: Subject to Negotiation (STN), STN2, Key, Key2, Key3, Teamster, Production Assistant (PA), Editor, Asst Editor, Post Supervisor. Variable ODC percentage and Labor percentage will be discussed in more detail.

The Variable ODC and Labor Percentage include both Variable ODC and Labor percentages that are determined in a similar manner. In both cases, a budget line-item specific threshold budget is used to determine the calculation approach. If the project budget is less than the threshold, then a first order polynomial equation is used, as shown in Equation 3.

$$\% = {O}_{1} + ( {O}_{2} * {B}_{o} ) \qquad Equation 3$$

$$Budget \% for lower than threshold films .$$

Where:
   %=The percentage of the variable ODC or variable labor budget.
   O₁ through O₂ are polynomial coefficients.
   Bₒ=The ODC variable or labor variable budget.

If the project budget is over the threshold, then a second order polynomial equation is used, as shown in Equation 4.

$$\% = {O}_{1} + ( {O}_{2} * {B}_{o} ) + ( {O}_{3} * {B}_{o}^{2} ) \qquad Equation 4$$

$$Budget \% for higher than threshold films .$$

Where:
   %=the percentage of the variable ODC or variable labor budget.
   O₁ through O₂ are polynomial coefficients.
   Bₒ=The ODC variable or labor variable budget.

In both the case of variable ODCs and the labor percentages, the formulas just defined are used to compute the median percentage for the budget line item. Each line item also contains four shaping parameters, expressed as percentages, which define the values at the +/− one standard deviation and +/− two standard deviation points. These shaping parameters allow each budget line-item value to be viewed as a normal or skewed distribution (based on the shaping parameter values), and those distributions can then be used by the calculation routines to compute values with varying degrees of confidence, based on where the values are pulled from the probability curve.

The genre specific adjustment data is determined as the procedures above provide us baseline probability curves for each budget line item, and it is necessary to adjust specific line items up or down based on the film's genre. For example, science-fiction films will require higher amounts of special effects work while an action film will require additional stunt work.

An adaptive adjustment table is used to adjust the computed values based on the selected film genre. This two-dimensional table contains adjustments for each genre and for each budget line item. These values are determined using historic data and expert judgement, stored in the system, and then adaptively increased or decreased based on observed actual budget data. In addition, the following genre specific adjustments are stored and applied during subsequent computational work: A stunt adjustment that is used to compute the number of stunt days, as described in Calc_Project. An ODC specific multiplier that is used to adjust the ODC budget for the film. A Labor specific multiplier that is used to adjust the labor budget for the film. A genre specific adjustment to expected international revenue and expected domestic revenue, using a combination of expert system rules and references to genre specific historic revenue data. The Period Specific Adjustment Data is computed in a manner like genre specific adjustments, the period of the film will have an impact on specific budget line-items. For this adjustment, “Present Day” is treated as the baseline.

Any period, whether forward in time or backward in time, will then have a cost impact (increase) for specific budget line-items. This configuration data stores those adjustments as percentage increases for each selectable period versus each budget line-item. The following are example of selectable periods: Ancient (60,000 BC to 650 AD), Middle Ages (651 AD to 1300), Renaissance (1301-1700), Early Modern (1701-1835), Victorian (1836-1913), WWI (1914-1918), Roaring Twenties (1919-1929), Depression (1929-1939), WWII (1939-1945), Post War (1946-1949), 1950s (1950-1959), 1960s (1960-1969), 1970s (1970-1979), 1980s (1980-1989), 1990s (1990-1999), 2000s (2000-2010), Present, Near Future (2024-2123), Future (2124 or greater).

The budget modeling sub-system (200) includes a budget processing unit (204) that is a computer modeling portion of the subsystem is the target film budget. The budget processing unit (204) uses a dynamic modeling approach to perform goal seeking, attempting to provide a constraint optimized budget that is near the target budget. The constraints are derived from the historic project data and templates (206), plus the expert system rules embedded within the system dynamic sub-models (204). Those sub-models consist of: a Calc_LBU, a Calc_Project., a Calc_Crew, and a Calc_Budget. Each of these are discussed individually below.

The Calc_LBU sub-model is used to calculate labor build-ups for the various film industry union contracts. The Calc_LBU includes business rules that define the contract tiers and tier specific labor rate related terms and conditions for contracts, including the Writer's Guild of America (WGA), Director's Guild of America (DGA), Screen Actors Guild (SAG), International Alliance of Theatrical Stage Employees (IATSE), International Brotherhood of Teamsters (IBT), plus benchmark data for non-union staff. Rate data is calculated based on labor category (e.g., WGA, DGA, Key Cast, SAG, Extras, STN, STN2, Key, Key2, Key3, Teamster, PA, Editor, Asst Editor, Post Supervisor.) For each labor category, contract, and film budget specific tier, the Calc_LBU determines the contract compliant fixed price amount (where applicable) or hourly direct rate, the hourly fringe amount, the Health, Welfare, and Pension (H&W&P) payment, and subsequent fully loaded rate.

The Calc_LBU also uses contract provisions regarding hours worked per day to determine the prep day rate, the shoot day rate, and the wrap day rate after allowing for overtime charges. As part of its analysis, the Calc_LBU identifies an optimum contract budget that is below the user specified budget limit (an input to the model), but that aligns with various union contract thresholds to minimize costs.

The approach to determining a target film budget is as follows. The threshold amounts at which all film-related union contracts step up is determined. This list, across all such contracts, is then sorted. The result is a list of step points across all contracts. Fixed price and labor rate data for all contracts is then stored at each of those step points, so at each step one or more contract required labor rates or fixed price amounts will change. The resultant matrix is expressed as List_Budget. The maximum budget for the film is derived from user input and treated as an independent input variable. Using List-Budget, the appropriate step value is located that is immediately below (lower than) the budget. The budget value is then considered the optimization target in terms of film budget.

$$Rate = Direct + Fringe + H \& W \& P \qquad Equ \text{?} ation 5$$

$$Computing the fully loaded rate .$$

$$\text{?} \text{indicates text missing or illegible when filed}$$

When computing the day rate by labor category for prep, shoot, and wrap, the Calc_LBU uses the typical number of hours worked per day by that labor category during that phase of work, and then applies the fully loaded labor rate for the initial eight hours of work and an overtime adjusted rate for hours worked over eight hours per day. When computing the fully loaded rate, the formula shown in Equation 5 is used. The rates for fringe and H&W&P are defined within the specific union contracts.

A Calc_Project sub-model is used to calculate and assemble project summary data, consisting of: Film production days, broken down into Prep Days, Shoot Days, Stunt Days, Wrap Days, and Post Days. Using data from the Calc_Crew sub-model, calculations of the required crew size for prep, shoot, and wrap. An optimum number of key-cast, expected number of person days for extras. A Variable and fixed budgets for labor and ODCs. Other budget costs, including contingency, finance fees, and completion bond fee. Shoot day allocations between shoot locations when the film uses multiple shoot locations.

The target costs for variable ODC costs are computed as shown in Equation 6, for fixed cost ODCs as shown in Equation 7, for other ODC costs as shown in Equation 8, for total labor costs as shown in Equation 9, and for the variable labor costs as shown in Equation 10.

$${ODC}_{v} = {O}_{1} + ( {O}_{2} * B ) + ( {O}_{3} * {B}^{2} ) \qquad Equation 6$$

$$Variable ODC calculation .$$

Where:
   ODCᵥ=The variable ODC target.
   O₁ through O₃ are polynomial coefficients.
   B=The film target budget.

$${ODC}_{f} = {\sum }_{i = 0}^{n} {F}_{n} * {O}_{n} \qquad Equation 7$$

$$Fixed price ODC calculation .$$

Where:
   ODC_{f}=The fixed price ODC target.
   F_{R}=The fixed price ODC cost for each budget line-item n.
   Oₙ=The ODC adjustment for each budget line-item n.

$${ODC}_{o} = \frac{B}{( 1 + \% )} * {\%}_{f} \qquad Equation 8$$

$$ODC - other calculation .$$

Where:
   ODCₒ=The ODC—other target.
   B=The flim target budget.
   %ₜ=The total % fee charged for other costs (e.g., contingency, finance fees, completion bond fees).

$${L}_{t} = B - {ODC}_{t} \qquad Equation 9$$

$$Total Labor calculation .$$

Where:
   Lₜ=The total labor target.
   B=The film target budget.
   ODCₜ=The total ODC budget (fixed, variable, plus other).

$${L}_{v} = {L}_{t} - {\sum }_{i = 0}^{n} {FL}_{n} \qquad Equation 10$$

$$Total variable labor calculation .$$

Where:
   Lᵥ=The variable labor target.
   Lₜ=The total labor target.
   FLₙ=The fixed price labor costs for each budget line-item n.

Shoot days are computed as previously described in Equation 1. Prep days, wrap days, and post days are then computed by multiplying the shoot days by appropriate constants, where the constants are adaptable based on system learning. Stunt days are computed by multiplying the shoot days by an appropriate constant, then multiplying that value by a genre specific stunt adjustment. The crew size is computed using the formula shown in Equation 11.

$$CS = c + ( d * S * {B}_{m} ) \qquad Equation 11$$

$$Crew size in FTE .$$

Where:
   CS=The crew size in full-time equivalents.
   c=A constant that adapts with learning.
   d=A constant that adapts with learning.
   S=Shoot days.
   Bₘ=Film budget in millions of dollars.

Films incur a significant cost for extras, which are the background people without speaking roles. The number of extra days, expressed in person days, is computed as shown in Equation 12.

$$Extras = ( {O}_{1} + ( {O}_{2} * B ) + ( {O}_{3} + {B}^{2} ) ) * g \qquad Equation 12$$

$$Extras in person - days calculation .$$

Where:
   Extras=The number of extras, expressed in person-days.
   O₁ through O₃ are polynomial coefficients.
   B=The film target budget.
   g=A genre specific adjustment.

A Calc_Crew sub-model is used to determine the below the line staffing by film production phase (Prep, Shoot, Wrap, and Post) and staff category (e.g., Key, Teamster, Editor), along with the associated labor costs. The Calc_Crew uses as input the number of production days (from the Calc_Project sub-model); the labor budget by line item (from the Calc_Budget sub-model); and the labor rates and allocations (from the Calc_LBU sub-model). The outputs include the number of Full-Time-Days (FTDs) for each phase, the Full-Time Equivalent (FTE) headcount by phase, and FTD by labor role and budget line item.

Staffing for prep, shoot, and cast are determined using one set of adaptable proportionality constants, and in a similar way prep, shoot, and cast target budget allocations are determined using a second set of adaptable proportionality constants. In both cases, the results are converted to percentages such that the total days and total target budgets each add to 100%. Prep, shoot, and cast combined percentages are computed using Equation 13, and the results are then normalized such that the percentages for the three phases total to 100%.

$${T}_{p} = D {\%}_{p} * S {\%}_{p} * B {\%}_{p} * \qquad Equation 13$$

$$Total target percentage by film phase .$$

Where:
   Tᵥ=Total (combined) phase percentage, with p corresponding to the prep, shoot, and wrap phases.
   D %ₚ=The phase percentage of total days, from Calc_Project.
   S %ₚ=The adaptable and normalized phase percentage of staffing by phase (normalized to 100%).
   B %ₚ=The adaptable and normalized labor budget percentage by phase for non-fixed price labor (normalized to 100%).

These normalized phase percentages are then used to compute the budget for each phase of work for each budget line item using Equation 14.

$${B}_{np} = {NT}_{p} * {L\$}_{n} \qquad Equation 14$$

$$Labor budget by phase and budget line item .$$

Where:
   Bₙₚ=The variable labor budget, by phase, for each budget line item.
   NTₚ=The normalized phase variable labor percentage.
   L$ₙ=The total variable labor budget for each budgetary line item, as computed within Calc_Budget.

Equation 15 is then used to compute the number of FTDs for each labor category, each phase, and each budget line item.

$${FTD}_{nlp} = \frac{{B}_{np} * L {\%}_{nlp}}{{L\$}_{lp}} \qquad Equation 15$$

$$Fulltime person day calculation .$$

Where:
   FTDₙᵢₚ=A three-dimensional matrix of the number of full-time person-days for each budget line item, each labor category, and each phase.
   Bₙₚ=The variable labor budget, by phase, for each budget line item.
   L %ₙᵢₚ=The percentage of labor allocation for each budgetary line item, each labor category, and each phase, as computed within Calc_LBU.
   L$ₗₚ=The labor category day rate for each phase, as computed within Calc_LBU.

The number of total FTD by phase is computed by summing the FTD across all budget line items and all labor categories for each phase, as shown in Equation 16.

$$\text{?}$$

$${FTD}_{p} = {\sum }_{i = 0}^{n} {\sum }_{0} \text{?} {FTD}_{n} \text{?} \qquad Equation 16$$

$$Fulltime days by phase .$$

$$\text{?} \text{indicates text missing or illegible when filed}$$

The number of FTE (crew size) for each phase (FTEp) is then computed as the FTD for that phase (from Equation 16) divided by the duration of that phase (from Calc_Project), as shown in Equation 17.

$${FTE}_{p} = \frac{{FTD}_{p}}{{D}_{p}} \qquad Equation 17$$

$$FTE staffing by phase .$$

A Calc_Budget computation begins by assembling and computing the following variables both for each budget line item and as totals by variable: Category: The budget line-item category, from Config_Budget, Acct #: The budget line-item accounting code, from Config_Budget, Description: The budget line-item description, from Config_Budget, Final Labor: The budget line-item final labor for subsequent calculations, which is the override amount if an override is entered, or the computed amount otherwise, Final ODC: The budget line-item final ODC for subsequent calculations, which is the override amount if an override is entered, or the computed amount otherwise, Adjustment Labor: The budget line-item user input labor ordinal adjustment, from Very Low to Very High, Adjustment ODC: The budget line-item user input labor ordinal adjustment, from Very Low to Very High.

A Forecast Labor: The budget line-item Final Labor (below), stored here for convenience, Forecast ODC: The budget line-item Final ODC (below), stored here for convenience, A Override Labor: The budget line-item optional user entered labor override, A Override ODC: The budget line-item optional user entered ODC override.

An ODC Override %: The budget line-item user entered ODC budget override percentage or 100% if no user ODC override is entered. An ODC Tot $: The sum of ODC FP plus ODC % $ for this budget line item.

An ODC FP: The budget line-item fixed price ODC amount from Config_Budget ODC % $: The variable ODC target multiplied by Final ODC % (below). Final ODC %: The budget line-item percent allocation, computed by adjusting the adjusted variable for this line item (below) such that Final ODC % will total 100% across all budget line items.

Adjusted: The budget line-item percentage, computed by multiplying ODC Adj by ODC % (both below). ODC Adj: The budget line-item total adjustment for genre and period, computed by multiplying the Genre Multiple by the Period Multiple (below). ODC %: The budget line-item variable ODC percentage, from Config_Budget. Crew $ for FTE: The budget line-item crew total variable cost, computed by multiplying the Override % time Crew Total. Override %: The budget line-item override % based on user override of labor budget.

If there is no user override, then this is 100%. If there is a user override for this line item, then this is the override amount divided by the sum of the fixed price and variable price labor for this line item. Final Labor: The budget line-item final total labor cost, computed as the sum of Labor FP and Crew Total. Labor FP: The budget line-item fixed price labor component, from Config_Budget. Crew Total: The budget line-item, the sum of Labor Crew FP and Labor % $.

Labor Crew FP: The budget line-item, the fixed price labor crew component from Config_Budget. Labor % $: The budget line-item variable labor dollars, computed as Final Labor % multiplied by the target variable labor budget. Final Labor %: The budget line-item variable labor percentage, normalized such that the total across all budget line-items will be 100%.

Adjusted: The budget line-item total adjustment, computed as Labor Adj multiplied by Labor %. Labor Adj: The budget line-item total adjustment for genre and period, computed by multiplying the Genre Multiple by the Period Multiple (below). Labor %: The budget line-item variable labor percentage, from Config_Budget. Genre Multiple: The budget line-item adjustment based on film genre, as a percentage. Period Multiple: The budget line-item adjustment based on film period, as a percentage.

For each budget line item, Calc_Budget uses the above data to provide the final labor budget, ODC budget, and total budget. Users can specify portions of the budget amount to be deferred (deferred compensation). Those deferred compensation amounts are also stored within Calc_Budget. The Calc_Budget computes totals for labor, ODCs, combined total, and deferred amounts for each of the budget categories (e.g., Above-the-line, Production, Post-Production, G&A, contingency, finance fees, and completion bond fees.)

For each labor category (e.g., key cast, SAG, Extras, IATSE, Teamsters, PA), the Calc_Budget queries Calc_LBU and determines the appropriate union contract based on the film actual budget. The Calc_Budget calculates and displays the total staff size by contract; the days for each phase of work (e.g., prep, shoot, stunt, wrap, post); and the crew size for each phase of work. Finally, Calc_Budget computes the film milestone schedule with start dates for prep, shoot, wrap, post, and release.

A Calc_ODC_Travel sub-model is used to calculate travel related ODCs for Above-the-Line (ATL), Below-the-Line (BTL), and cast. Default expenses by traveler (FTE) for airfare (per trip), lodging (per day), per-diem, and local transportation (per day) are defined using a step function whereby the default rates vary based on the computed budget of the film. The total number of travel days for each category of staff, and each phase of work, is computed using Equation 18.

$${TD}_{n} = {k}_{np} {Days}_{p} \qquad Equation 18$$

$$Computing travel days by staff category .$$

Where:
   TDₙ=Travel days for a given category of staff (ATL, BTL, or Crew), n.
   kₙₚ=An adaptable travel constant multiple specific to each category of staff (n) and each phase of work (p), where the phases of work are prep, shoot, and post.
   Daysₚ=The total days allocated for each phase of work (p).

Default traveler quantities are computed differently for ATL, BTL, and cast travelers. Each will be discussed separately. ATL traveler quantity is computed using a step function, based on film budget. Cast traveler quantity is computed using Equation 19.

$$Trav = Key \text{?} ( k * Cast ) \qquad Equation 19$$

$$Cast traveler quantity$$

$$\text{?} \text{indicates text missing or illegible when filed}$$

Where:
   Trav=Cast travelers.
   Key=Number of key cast, from Calc_Project.
   k=A film budget specific constant, using a step function.
   Cast=Total cast days, excluding extras, from Calc_Project.

To compute BTL traveler quantity, the process begins by computing the range of potential BTL travel budgets, defined as the high value (BTL$h, Equation 20), and the low value (BTL$1, Equation 21.)

$${BTL\$}_{h} = {O}_{1} + ( {O}_{2} * B ) + ( {O}_{3} * {B}^{2} ) + ( {O}_{4} * {B}^{2} ) \qquad Equation 20$$

$$Computing the BTL travel budget top of range .$$

Where:
   BTLSₕ=The BTL travel budget top of range.
   O₁ through O₄ are polynomial coefficients.
   B=The film target budget.

$$BTL\$ \text{?} = {O}_{1} + ( {O}_{2} * B ) \qquad Equation 21$$

$$Computing the BTL travel budget bottom of range .$$

$$\text{?} \text{indicates text missing or illegible when filed}$$

Where:
   BTIS₁=the BTL travel budget bottom of range.
   O₁ through O₂ are polynomial coefficients.
   B=The film target budget.

Further, the cost per BTL traveler (Ct) is computed using Equation 22.

$${C}_{t} = ( T * {\$}_{t} ) = ( Days * {\$}_{d} ) \qquad Equation 22$$

$$Computing the BTL cost per traveler .$$

Where:
   C=The cost per BTL traveler.
   T=The number of trips per BTL traveler.
   Sₜ=The air transportation and transfers cost per BTL trip.
   Days=The number of days spent in a travel capacity from Equation 18.
   S₄=The daily cost per BTL traveler.

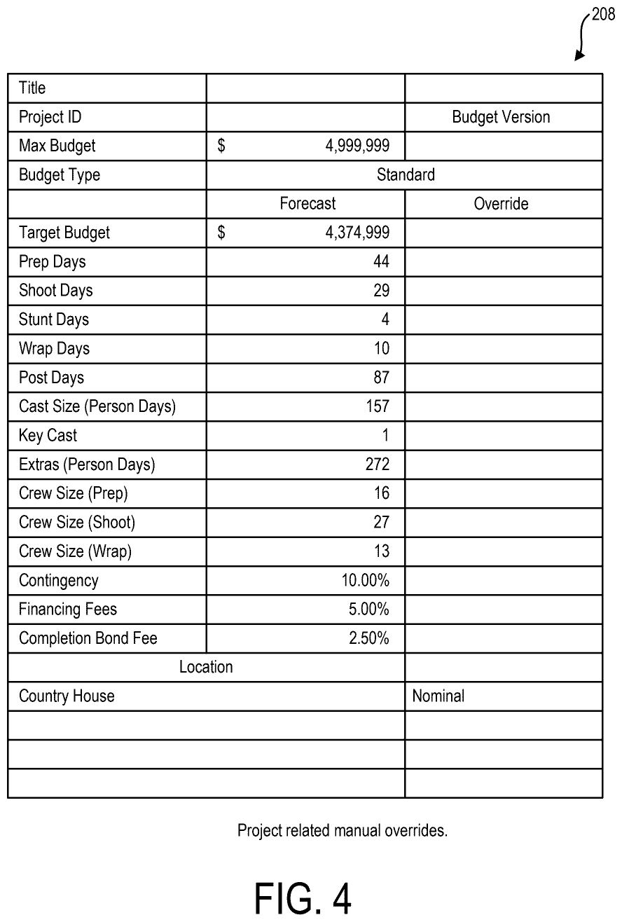

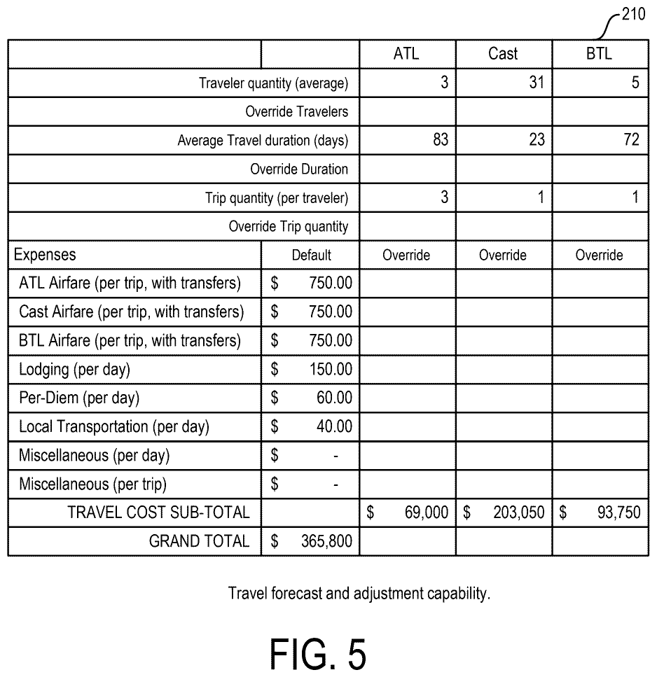

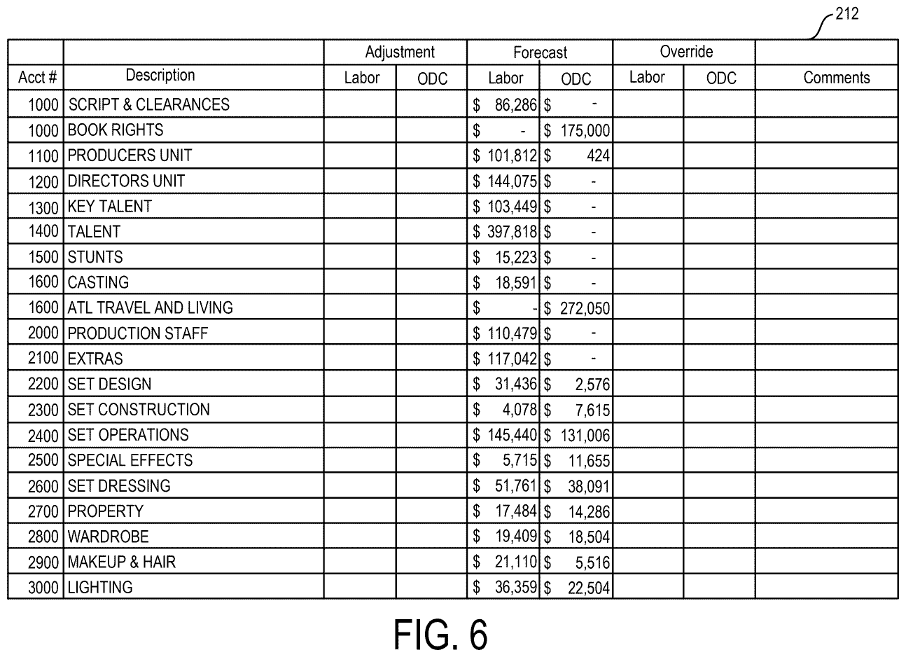

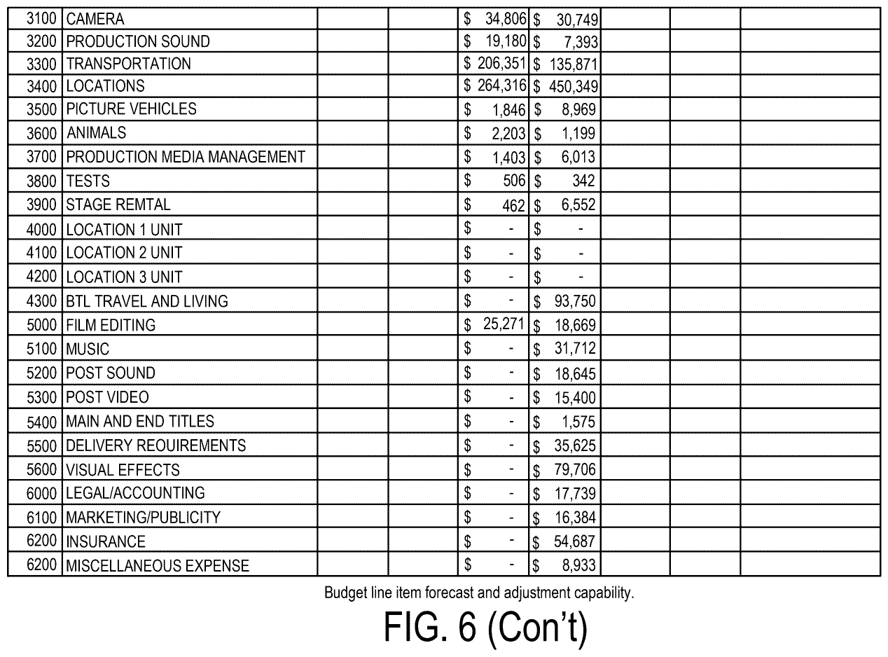

The BTL travelers are then computed by selecting a value between BTLI and BTLh based on the film budget and dividing that target BTL budget by Ct from Equation 22. A Schedule and Budget Manual Overrides (210) in the system displays calculated values, and allows the user to manually override those values, using the user input screens shown in FIG. 4 (overall project override), FIG. 5 (travel related overrides), and FIG. 6 (budget overrides). In each case, the calculated values are shown in dark or medium beige, and the user overrides are entered into the cells shown in white. The system uses the override values to replace the calculated values, and then re-runs all internal calculations such that the new calculated values are consistent with the entered override values.

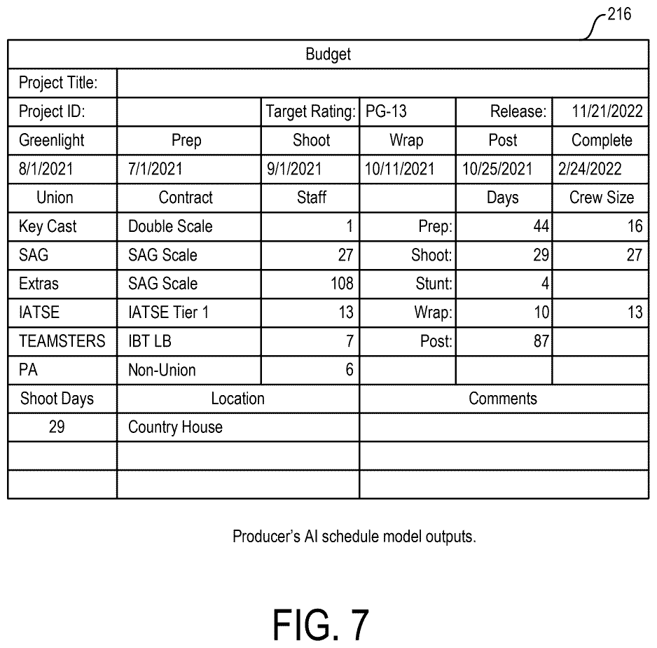

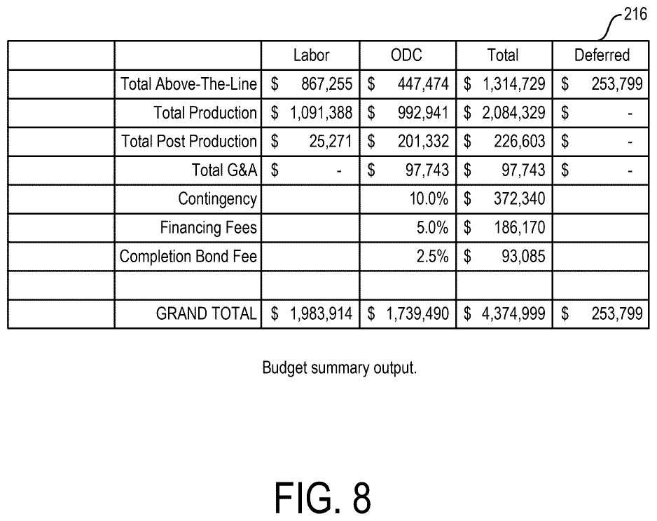

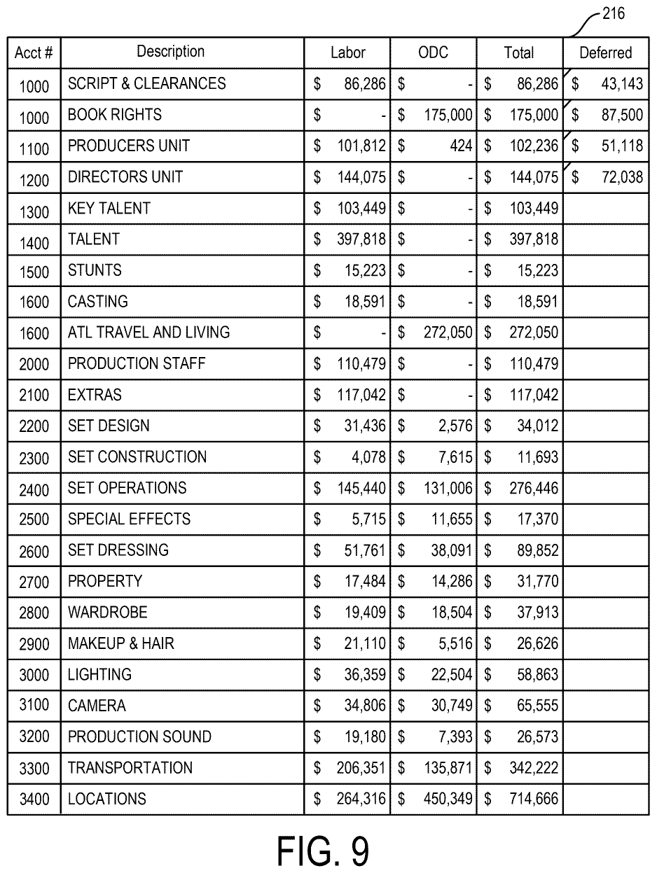

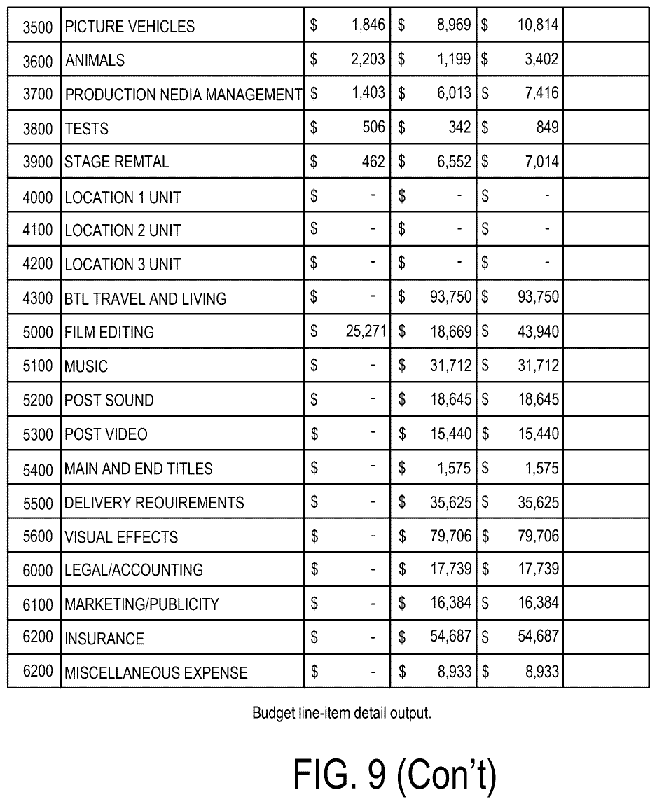

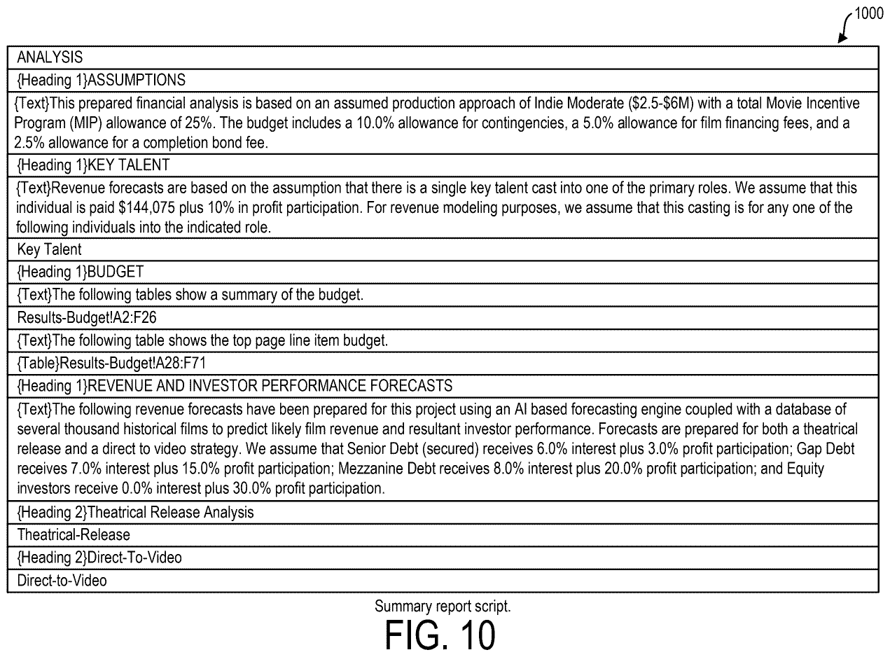

A Reports and Other Outputs (216) is the output of the budget modeling sub-system (200). An on-screen output includes outputs displaying the final project schedule as shown in FIG. 7, budget summary as shown in FIG. 8, and budget line-item detail as shown in FIG. 9. Output Reports uses Office Automation (OA) to output reports to Microsoft Word. Reports are generated using a custom report script language consisting of: Keywords telling the system report generation engine the type of report script data (e.g., a heading, text, a table) and the data itself. The data may be textual data or reference data to the system spreadsheets, either in the form of addresses or named ranges. A sample report script is shown in FIG. 10.

A Movie Magic budgeting software (218) uses extended Markup Language (XML) files with a .mmbx extension to transfer data from the system to Movie Magic budgeting software.

The Movie Magic budgeting software uses optimization functionality to optimize uses Visual Basic for Applications (VBA) code to optimize variables to maximize value in terms of an objective with specified constraints. For example: Objective: Maximize the ratio of total film revenue in the event of a bomb (poor performing film) to the film budget; Variables: Maximum union contract budget threshold (Max_Budget) and film target budget (Actual_Budget); Constraints: A combination of union contract thresholds and the budget range under consideration; and Following optimization, the optimum values for the variables (in this case, Max_Budget and Actual_Budget) are entered into the tool.

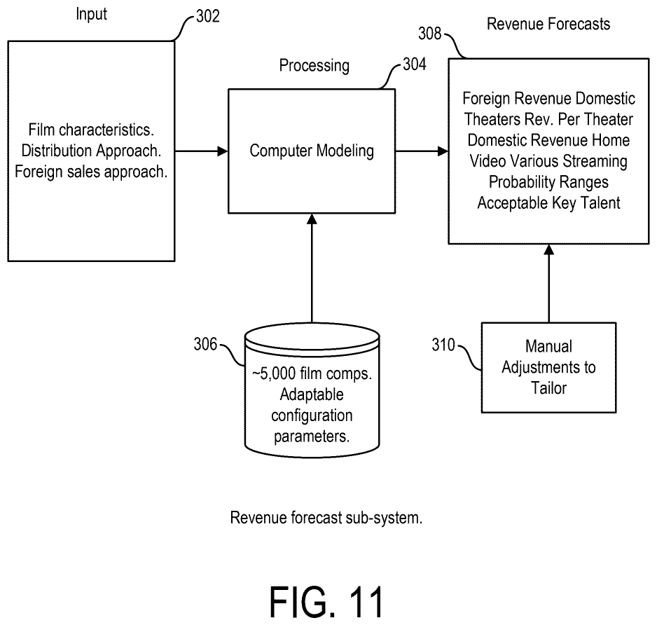

The system (100) includes a revenue forecasting sub-system (300) for generating a revenue forecast and performing cash-flow analysis. As shown in FIG. 11, the revenue forecasting sub-system (300) includes a revenue input unit (302) that takes as input various film characteristics, the film distribution approach, and the foreign sales approach. The revenue input unit (302) applies adaptable configuration parameters plus historic data from previous films, uses computer models, and forecasts the range of foreign revenue, domestic theaters, domestic revenue per theater, domestic theater revenue, home video revenue, and streaming revenue. Because revenue forecasts are influenced by creative packaging (specifically, casting and selection of a director), this sub-model also outputs specific casting candidates for each project role that are compatible with the model assumptions. The Input Data includes film budget data from the budget modeling subsystem discussed above are transferred to the revenue forecasting sub-system, and Input-Revenue, Input-Foreign Sales, and Revenue Forecast Configuration Data. Each of these is described below.

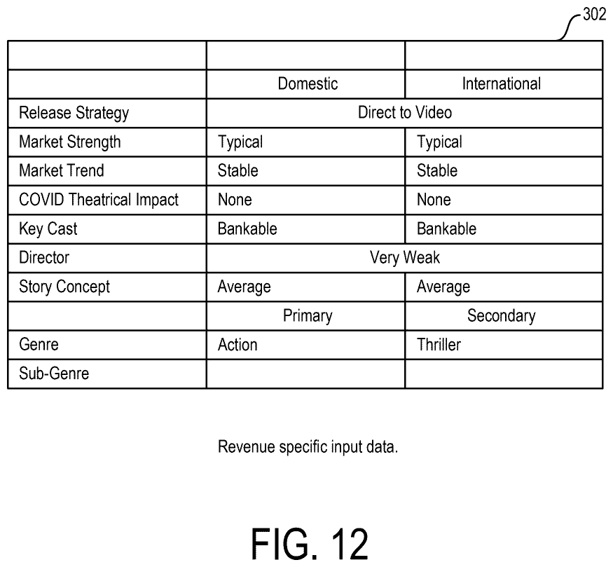

The Input-Revenue includes primary revenue calculation film specific input in addition to budget data from the budget modeling subsystem as shown in FIG. 12. These are: The release strategy. Examples include Theatrical, Direct to Video, or Day and Date; The assumed domestic (U.S.) and international market strength relative to historic data, selectable from Very Weak, Weak, Typical, Strong, and Very Strong; The assumed domestic and international market trend, selectable from Strong Down, Down, Stable, Up, and Strong Up; The assumed domestic and international impact of COVID or other similar disruptive events, selectable from None, Low, Moderate, High, and Very High.

The Key Cast domestic and international value, selectable from Very Weak, Weak, Bankable, Strong, and A-List; The Director value, selectable from Very Weak, Weak, Bankable, Strong, and A-List; The story concept domestic and international value, selectable from Very Weak, Weak, Average, Strong, and Very Strong; and the film's primary and secondary genre, plus the sub-genre within the primary genre.

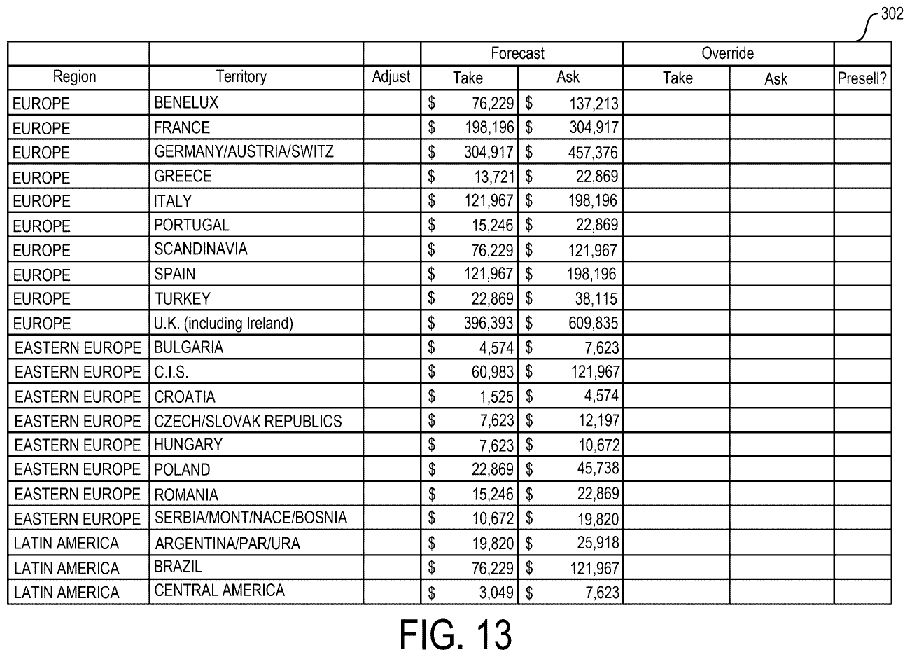

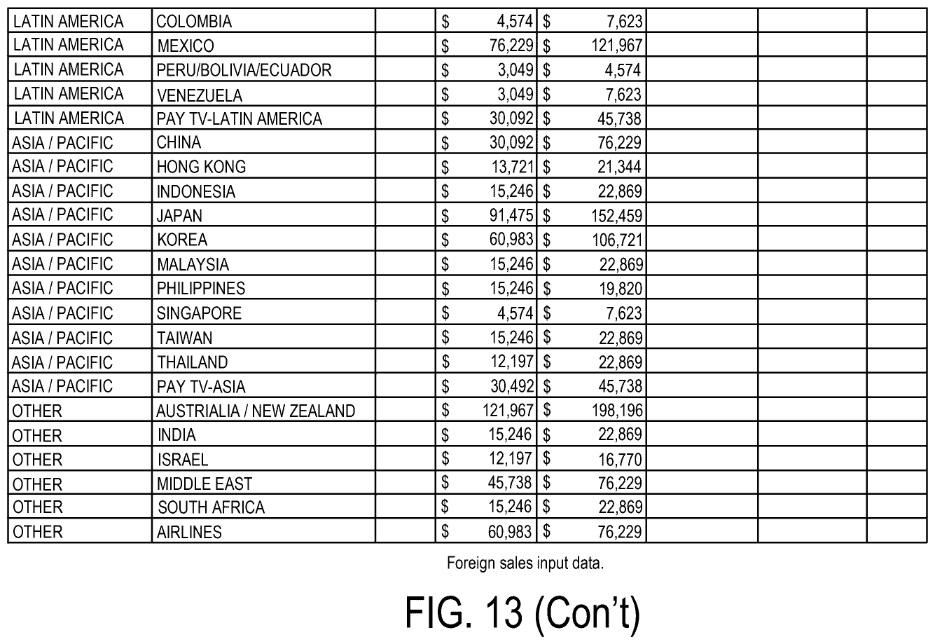

The Input-Foreign Sales includes the foreign sales related model user inputs are shown in FIG. 13. The system calculates the expected Take and Ask, using the approach described below when discussing calculations. For each foreign territory, the user can adjust the calculation based on territory specific characteristics of the film, using an adjustment of Very High, High, Nominal, Low, or Very Low. The system then applies these adjustments to each territory to increase or decrease the expected values for Take and Ask, as described below. The user is also able to manually override the values for Take and/or Ask for each of the territories, if the user has offers in hand or better data available than the calculations based on historical benchmarks. Finally, the user can identify which territories will be presold (if any). The presale data is then used by the Investor Waterfall Subsystem.

The Revenue Forecast Configuration Data includes Config_ForeignSales; Config_Comps; Config_Cast; Config_Revenue; and Config_Talent. Each of these will be discussed individually.

The Config_ForeignSales contains a list of the foreign territories, a benchmark data based relative percentage for each foreign territory such that the sum of the percentages total to 100%, plus a standard deviation associated with each foreign territory. The Config_Comps contains a dataset of historic film theatrical performance, plus calculated values using that data. The historic film dataset includes: Movie Title including the title of the movie; Studio including the studio that distributed the movie; Gross including Theatrical gross revenue, adjusted to current year dollars; Theaters including Number of theaters; Open including Opening date for theatrical release; Close including Closing date for theatrical release; Year including year of theatrical release; and Rev per Theater including Revenue per theater, adjusted to current year dollars.

From this dataset, a film released to less than 100 theaters is excluded, assuming that those films were using a day-and-date release approach. From the resultant filtered dataset, the number of theaters and revenue per theater is computed as follows: Bomb including the 1st quartile of the filtered dataset; Low including the median of the filtered dataset; Expected including the mean of the filtered dataset; High including the 3rd quartile of the filtered dataset; and Hit including the mean plus 1 standard deviation of the filtered dataset.

For both the number of theaters and revenue per theater, the system also computes the delta from the computed value (bomb, low, high, or hit) to the expected value, expressed as a percentage.

Config_Cast contains data on several hundred actors. Specifically, their name, sex, birthdate (year), and financial value. Value is one of the following ordinal values: A-List; Strong; Bankable; and Weak. Values are assigned based on current value in the film marketplace. A-List offer the most value, followed by Strong, then Bankable, and finally, Weak. Note that even actors with an assigned value of weak offer value to a film in an ensemble situation or for smaller budget films. Actors that do not offer any actor specific financial value to the project would not be on the list.

The Config_Revenue contains adaptable revenue category constants plus genre and sub-genre adjusting historic benchmark constants. The adaptable revenue category constants are: Domestic Box Office including a constant used when computing the domestic box office; Theater share including a constant used when computing the domestic box office split between the theater and the distributor; Distribution fee including a constant used when computing the distribution fees; Prints and advertising (per screen) including a constant used when computing the prints and advertising budget; Home Video including a constant used when computing the home video revenue; Distribution fee including a constant used when computing the home video distribution fee; Production expense including a constant used when computing the home video production expense; Residuals including a constant used when computing home video residuals.

Video On Demand (VOD), Streaming VOD (SVOD), Ad supported VOD (AdVOD) including a constant used when computing the VOD, SVOD, and AdVOD revenue. Pay TV, Pay Per View (PPV), Free TV including a constant used when computing the Pay TV, PPV, and Free TV revenue; Television &VOD Distribution Fee including a constant used when computing the Television and VOD distribution fee; and Television Residuals including a constant used when computing the Television residuals.

Genre (e.g., Armageddon) and sub-genre (e.g., Post-Apocalypse, Zombie) adjustments are developed as follows. Further, the process begins by determining the adjustments for each sub-genre, using a historic dataset of over 15,000 films with an average of 188 films per sub-genre. For each sub-genre, the following benchmark data is stored for the historic film release data: Films including the number of films in the historic dataset; Average Rev. including the average revenue for films released in this sub-genre, adjusted to current year dollars; Average Theaters including the average number of theaters for films released in this sub-genre; wide Release Rev. including the average revenue for wide release films in this sub-genre, adjusted to current year dollars; and Wide Release Theaters including the average number of theaters for wide release films in this sub-genre.

The sub-genre theater and revenue adjustments are computed using Equation 23 and Equation 24 respectively, for both the full dataset and the wide release dataset.

$${aT}_{n} = \frac{{T}_{n}}{( \frac{{\sum }_{i = 0}^{n} {T}_{n}}{n} )} \qquad Equation 23$$

$$Sub - genre theater adjustment .$$

Where:
   aTₙ=The Theater adjustment for a given sub-genre n. expressed as a percentage.
   Tₙ=The average number of theaters for films of this sub-genre.

$${aR}_{n} = \frac{{R}_{n}}{( \frac{{\sum }_{i = 0}^{n} {R}_{n}}{n} )} \qquad Equation 24$$

$$Sub - genre revenue adjustment .$$

Where:
   aRₙ=The revenue adjustment for a given sub-genre n, expressed as a percentage.
   Rₙ=The average revenue for films of this sub-genre.

The sub-genre data is then used to compute adjusting factors for each genre, as shown in Equation 25 and

$$\text{?}$$

$${AR}_{p} = {k}_{p} \frac{\frac{{\sum }_{i = 0}^{n} {Rev}_{n}}{n}}{( \frac{{\sum }_{g = 0}^{p} {R}_{g}}{p} )} \qquad Equation 26$$

$${AT}_{p} = {k}_{p} \frac{\frac{{\sum }_{i = 0}^{n} {T}_{n}}{n}}{( \frac{{\sum }_{g = 0}^{p} {T}_{g}}{p} )} \qquad Equation 25$$

$$Genre theater adjustment .$$

$$\text{?} \text{indicates text missing or illegible when filed}$$

Where:
   ATₚ=The Theater adjustment for a given genre p, expressed as a percentage.
   kₚ=An adaptive genre specific constant that is used to adjust for external factors such as popularity trends.
   Tₙ=The number of Theaters for each film n within this genre.
   T_{g}=The average number of theaters for each genre g.

$${AR}_{p} = {k}_{p} \frac{\frac{{\sum }_{i = 0}^{n} {Rev}_{n}}{n}}{( \frac{{\sum }_{g = 0}^{p} {R}_{g}}{p} )} \qquad Equation 2 \text{?}$$

$$Genre revenue adjustment .$$

$$\text{?} \text{indicates text missing or illegible when filed}$$

Where:
   ARₚ=The revenue adjustment for a given genre p, expressed as a percentage.
   kₚ=An adaptive genre specific constant that is used to adjust for external factors such as popularity trends.
   Revₙ=The current year adjusted revenue for each film n is genre.
   Rₛ=The average revenue for each genre g.

The revenue modeling sub-system includes a revenue processing unit includes computer modeling application that consists of the following three supporting models, each of which will be discussed individually: Calc_Cast; Calc_ForeignSales; and Calc_Revenue. The Calc_Cast purpose is to create a casting list of potential actors that both match the film casting requirements and that support the revenue forecasts. The generated casting list is comprehensive, but the actual required number of key cast that must be contracted is determined by the Budget subsystem and displayed on the Results-Budget output screen. For example, Calc_Cast might create a list of several dozen candidate actors for a half-dozen roles in the film, but only one of those actors for one of those roles might be required to support the revenue forecasts.

Calc_Cast uses as input the list of project roles, actor sex for each role, and actor age range for each role from the film specifications, combined with the key cast expected level (A-List, Strong, Bankable, Weak, or Very Weak) from the revenue assumptions input screen. For each film role, it then uses the sex, age range, and level to extract the suitable actors from the comprehensive actor list in Config_Cast.

The Calc_ForeignSales begins by computing candidate total foreign revenue, then allocates that revenue to foreign territories, then supports territory adjustments to arrive at the adjusted total foreign sales and final foreign sales by territory. The calculation of candidate total foreign revenue uses Equation 27.

$${R}_{f} = B * C * ( m ( {\prod }_{k = 1}^{n} {A}_{k} ) ) \qquad Equation 27$$

$$Candidate Foreign revenue calculation .$$

Where:
   R_{f}=The candidate foreign revenue, in dollars.
   B=The film target budget.
   C=The adjustment for one-time exceptional situations (e.g., Covid).
   m=An adaptable constant adjusted as part of machine learning.
   Aₖ=The following set of configurable and adaptable constants adjusted as part of machine learning.
      A₁=A parameter that varies based on the selected release strategy.
      A₂=A parameter that varies based on the selected market strength.
      A₃=A parameter that varies based on the selected market trend.
      A₄=A parameter that varies based on the selected key cast value to the selected market.
      A₅=A parameter that varies the selected director value to the selected market.
      A₆=A parameter that varies based on the selected story concept value to th selected market.
      A₇=A parameter that varies based on the film genre adjustment for the international market, calculated using Equation 28.

$${A}_{7} = {p}_{1} {g}_{p} + {p}_{2} {g}_{s} \qquad Equation 28$$

$$Film genre adjustment parameter .$$

Where:
   A₇=The film genre adjustment.
   p₁ and p₂=Weighting constants that total to 1.0 (100%).
   gₚ and gₛ=The genre adjustments for the primary (p) and secondary(s) genres of the film.

For each foreign territory, the take is then computed as the appropriate percentage of the candidate foreign territory based on percentages from Config_ForeignSales (the mean), reduced to correspond to the minus one standard deviation point. The ask is similarly computed as the appropriate percentage of the candidate foreign territory but at the plus one standard deviation point. Finally, user input with respect presell strategy is used to total presales as the sum of the take values for presell territories, and expected foreign revenue post release as the sum of the mean values for foreign territories that were not presold. In addition, the total standard deviation for non-presold foreign territories is calculated by summing the standard deviations for each individual foreign territory.

The Calc_Revenue sub-model is used to calculate the following revenue and expense values for five different film revenue probability scenarios (Bomb, Low, Expected, High, and Hit): Domestic Theaters (count); Revenue per Theater; Foreign Sales (Less Presold); Domestic Box Office; Theater share; Distribution fee; Prints and advertising; Theatrical Subtotal; Home Video; Distribution fee; Production expense; Theatrical Recovery; Residuals; Home Video Subtotal; VOD, SVOD, AdVOD; Pay TV, PPV, Free TV; Distribution Fee; Theatrical Recovery; Residuals; Streaming Subtotal; and GRAND TOTAL.

A Domestic Theaters (count) includes the expected number of domestic theaters and is calculated using Equation 29. The values for bomb, low, high, and expected are then computed using Equation 31.

$${T}_{e} = D * C * {T}_{m} ( m ( \sqrt{{\prod }_{k = 1}^{n} {A}_{k}} ) g ( \frac{{B}_{f}}{{B}_{t}} ) \qquad Equation 29$$

$$Domestic theater count calculation .$$

Where:
   Tₑ=The expected number of domestic Theaters.
   D=An adaptable distribution constant that varies based on The distribution approach.
   C=The adjustment for one-time exceptional situations (e.g., Covid).
   Tₘ=The mean Theaters from Config_Comps benchmark data.
   m=an adaptable constant adjusted as part of machine learning.
   B_{f}=The calculated budget for this film from the budget calculation sub-system.
   Bₜ=The typical budget for this genre of film, from Config_Comps.
   Aₖ=The following set of configurable and adaptable constants specific to domestic theatrical releases and adjusted as part of machine learning.
      A₁=A parameter that varies based on the selected release strategy.
      A₂=A parameter that varles based on the selected market strength.
      A₃=A parameter that varies based on the selected market trend.
      A₄=A parameter that varies based on the selected key cast value to the selected market.
      A₅=A parameter that varies based on the selected director value to the selected market.
   A₆=A parameter that varies based on the selected story concept value to the selected market.
   g=A parameter that varies based on the film genre adjustment for the domestic market, calculated using Equation 28. If a sub-genre is specified, then that adjustment is used. Otherwise, a weighted value of the primary and secondary genre is used.

$$g = \sqrt{( {g}_{sub} \vert {p}_{1} {g}_{p} + {p}_{2} {g}_{s} )} \qquad Equation 30$$

$$Film genre adjustment parameter .$$

Where:
   g=The film genre adjustment.
   p₁ and p₂=Weighting constants that total to 1.0 (100%).
   gₚ and gₛ=The genre adjustments for the primary (p) and secondary(s) genres of the nim.
   g_{sub}=The sub-genre adjustment if a sub-genre is specified.

$${T}_{c} = {T}_{e} * \sqrt{Δ T {\%}_{n}} \qquad Equation 31$$

$$Computing values for bomb , low , high , and hit .$$

Where:
   T_{c}=The number of theaters for each of the four alternate scenarios, c.
   Tₑ=The number of theaters for the expected case.
   ΔT %ₙ=The historic number of theaters for the alternate scenario n, expressed as a percentage of Tₑ.

Revenue per Theater includes the expected revenue per domestic theater and is calculated using Equation 33. The values for bomb, low, high, and expected are then computed using Equation 34.

$${T}_{r} = \frac{C * f ( {B}_{1} , {B}_{2} , \text{?} ) * {T}_{m} ( m ( \sqrt{{\prod }_{k = 2}^{n} {A}_{k}} ) g ( \frac{{B}_{f}}{{B}_{t}} )}{{T}_{e}} \qquad Equation 32$$

$$Domestic theater count calculation .$$

$$\text{?} \text{indicates text missing or illegible when filed}$$

Where:
   Tᵣ=The expected revenue per domestic Theater
   Tₑ=The expected number of domestic Theaters, from Equation 29.
   C=The adjustment for one-time exceptional situations (e.g., Covid).
   f(B₁, B₂, I)=A function on the current film budget (B₁); the mean film budget for other films in this genre, adjusted to current year dollars (Br); and an adaptable constant I. The function ( ) returns B₁ for amounts up to B₂, or B₁+1^{st}(B₁-B₂) for films with a budget over B₁.
   T=The mean theaters from Config_Comps benchmark data.
   m=An adaptable constant adjusted as part of machine learning.
   B_{f}=The calculated budget for this film from the budget calculation sub-system.
   Bₜ=The typical budget for this genre of film, from Config_Comps.
   Aₖ=The following set of configurable and adaptable constants specific to domestic theatrical releases and adjusted as part of machine learning.
      A₁=A parameter that varies based on the selected release strategy
      A₂=A parameter that varies based on the selected market strength
      A₃=A parameter that varies based on the selected market trend.
      A₄=A parameter that varies based on the selected key cast value to the selected market.
      A₅=A parameter that varies based on the selected director value to the selected market.
      A₆=A parameter that varies based on the selected story concept value to the selected market.
   g=A parameter that varies based on the film genre adjustment for the domestic market, calculated using Equation 33. If a sub-genre is specified, then that adjustment is used. Otherwise, a weighted value of the primary and secondary genre is used.

$$g = \sqrt{( {g}_{sub} \vert {p}_{1} {g}_{p} + {p}_{2} {g}_{z} )} \qquad Equation 33$$

$$Film genre adjustment parameter .$$

Where:
   g=The film genre adjustment.
   p₁ and p₂=Weighting constants that total to 1.0 (100%).
   gₚ and gₛ=The genre adjustments for the primary (p) and secondary (s) genres of the film.
   g_{zub}=The sub-genre adjustment if a sub-genre is specified.

$${R}_{c} = {R}_{e} * \sqrt{Δ R {\%}_{n}} \qquad Equation 34$$

$$Computing values for bomb , low , high , and hit .$$

Where:
   R_{c}=The expected revenue per theater, in current year dollars, for each of the four alternate scenarios, c.
   Rₑ=The revenue per theater, in current year dollars, for the expected case.
   ΔR %ₙ=The historic revenue per theater for the alternate scenario n, expressed as a percentage of Rₑ.

The Foreign Sales (Less Presold) is shown in Equation 35, foreign sales less presold is calculated for each film performance probability case (Bomb, Low, Expected, High, or Hit) by summing the foreign territory revenue forecasts for the probability case across all territories that were not presold.

$${F}_{c} = {{\sum }_{i = 0}}^{n} {R}_{i} \qquad Equation 35$$

$$Calculating foreign sales less presold .$$

Where:
   F_{c}=Foreign sales less presold for a given case (c) of Bomb, Low, Expected, High, or Hit.
   R₁=For the foreign territories that have not been presold, the expected foreign sales of that case for a given territory (i) of the n foreign territories, as computed within Calc_ForeignSales and described previously.

A Domestic Box Office includes in an analogous fashion, the domestic box office for each film performance probability case is calculated as in Equation 36.

$${D}_{c} = {T}_{c} * {R}_{e} \qquad Equation 36$$

$$Calculating domestic box office .$$

Where:
   D_{c}=Domestic box office gross sales for a given case (c) of Bomb, Low, Expected, High, or Hit.
   T_{c}=The forecast number of theaters showing the film for a given case.
   e=The expected average revenue per theater for a given case.

A Theater share of the domestic box office for each film performance probability case is calculated using Equation 37.

$${D}_{t} = {kD}_{c} \qquad Equation 37$$

$$Calculating theater share of domestic box office .$$

Where:
   Dₜ=The theater share of domestic box office gross sales for a given case (c) of Bomb, Low, Expected, High, or Hit.
   D_{c}=The forecast domestic box office for a given case.
   k=An adaptable constant.

A Distribution fee associated with the domestic box office for each film performance probability case is calculated using Equation 38.

$${D}_{d} = {ID}_{t} \qquad Equation 38$$

$$Calculating theater share of domestic box office .$$

Where:
   D_{d}=The distribution fees for a given case.
   Dₜ=The theater share of domestic box office gross sales for a given case (c) of Bomb. Low, Expected, High, or Hit.
   l=An adaptable constant.

The prints and advertising cost associated with the domestic box office for each film performance probability case is calculated using Equation 39.

$${D}_{p} = {mT}_{c} \qquad Equation 39$$

$$Calculating theater share of domestic box office .$$

Where:
   Dₚ=The prints and advertising fees for a given case (c) of Bomb, Low. Expected, High, or Hit.
   T_{c}=The number of theaters for a given case.
   m=An adaptable constant.

The theatrical subtotal revenue calculation is calculated using Equation 40.

$${R}_{c} = {D}_{c} - {D}_{t} - {D}_{d} - {D}_{p} \qquad Equation 40$$

$$Theatrical sub - total .$$

Where:
   R_{c}=Theatrical sub-total for a given film probability case (c) of Bomb, Low, Expected, High, or Hit.
   D_{c}=The forecast domestic box office for a given case.
   Dₜ=The theater share of domestic box office gross sales for a given case.
   D_{d}=The distribution fees for a given case.
   Dₚ=The prints and advertising fees for a given case.

The home video gross revenue is computed using Equation 41.

$${H}_{c} = {kD}_{ce} \qquad Equation 41$$

$$Home video gross revenue calculation .$$

Where:
   H_{c}=Home video gross revenue for a given film probability case (c) of Bomb, Low, Expected, High, or Hit.
   k=An adaptable constant.
   D_{ce}=Equivalent domestic box office gross sales for a given case. For films with a theatrical release, this will be the forecast domestic box office gross sales, however for films with a day-and-date or streaming only release, this value will be the forecast of what the domestic box office would have been if the film had a theatrical release.

The distribution fee associated with home video for each film performance probability case is calculated using Equation 42.

$${H}_{d} = {IH}_{c} \qquad Equation 42$$

$$Calculating home video distribution fees .$$

Where:
   H_{d}=The distribution fees for a given case.
   Hₑ=The home video gross sales for a given case (C) of Bomb, Low, Expected, High, or Hit.
   l=An adaptable constant.

The production expenses associated with home video for each film performance probability case are calculated using Equation 43.

$${H}_{p} = {mH}_{c} \qquad Equation 43$$

$$Calculating home video production expenses .$$

Where:
   Hₚ=The production expenses for a given case.
   H_{c}=The home video gross sales for a given case (c) of Bomb, Low, Expected, High, or Hit.
   m=An adaptable constant.

The Theatrical Recovery: If the theatrical sub-total Rc is negative for a given film probability case, then theatrical recovery (Ht) to make up the deficit becomes an expense of the home video revenue stream.

A Residuals expenses associated with home video for each film performance probability case is calculated using Equation 44.

$${H}_{r} = {nH}_{c} \qquad Equation 44$$

$$Calculating home video residuals .$$

Where:
   Hᵥ=The residuals expenses for a given case.
   H_{c}=The home video gross sales for a given case (c) of Bomb, Low, Expected, High, or Hit.
   n=An adaptable constant.

A Home Video Subtotal revenue calculation is calculated using Equation 45.

$${H}_{v} = {H}_{c} - {H}_{d} - {H}_{p} - {H}_{t} - {H}_{r} \qquad Equation 45$$

$$Home video sub - total .$$

Where:
   Hᵥ=Home video sub-total for a given nim probability case (c) of Bomb, Low, Expected, High, or Hit.
   H_{c}=Home video gross sales for a given case.
   H_{d}=The distribution fees for a given case.
   Hₚ=The production expenses for a given case.
      Hₜ=The theatrical recovery for a given case.
      Hᵣ=The residuals for a given case.

A plurality of VOD, SVOD, AdVOD includes the combined VOD, SVOD, and AdVOD gross revenue is computed using Equation 46.

$${V}_{c} = {vD}_{ce} \qquad Equation 46$$

$$VOD , SVOD , and AdVOD gross revenue calculation .$$

Where:
   V_{c}=Combined VOD, SVOD, and AdVOD gross revenue for a given film probability case (c) of Bomb, Low, Expected, High, or Hit.
   v=An adaptable constant.
   D_{cv}=Equivalent domestic box office gross sales for a given case. For films with a theatrical release, this will be the forecast domestic box office gross sales, however for films with a day-and-date or streaming only release, this value will be the forecast of what the domestic box office would have been if the film had a theatrical release.

Pay TV, PPV, Free TV: The combined Pay TV, PPV, and Free TV gross revenue is computed using Equation 47.

$${P}_{c} = {pD}_{ce} \qquad Equation 47$$

$$Pay TV , PPV , and Free TV gross revenue calculation .$$

Where.
   P_{c}=Combined Pay TV. PPV, and Free TV gross revenue for a given film probability case (c) of Bomb, Low, Expected, High, or Hit.
   p=An adaptable constani.
   D_{ce}=Equivalent domestic box office gross sales for a given case. For films with a theatrical release, this will be the forecast domestic box office gross sales, however for films with a day-and-date or streaming only release, this value will be the forecast of what the domestic box office would have been if the film had a theatrical release.

A Distribution Fee associated with all streaming markets for each film performance probability case is calculated using Equation 48.

$$\begin{matrix}Equation 48 : Calculating streaming video distribution fees & \\ {S}_{d} = r ( {V}_{c} + {P}_{c} ) . & \end{matrix}$$

Where:
   S_{d}=The distribution fees for a given case.
   V_{c}=Combined VOD, SVOD, and AdVOD gross revenue for a given film probability case (c) of Bomb, Low, Expected, High, or Hit.
   P_{c}=Combined Pay TV. PPV, and Free TV gross revenue for a given film probability case (c) of Bomb, Low, Expected, High, or Hit.
   r=An adaptable constant.

A Theatrical Recovery: If the theatrical sub-total (Rc) plus the theatrical recover from home video sales (Ht) is negative for a given film probability case, then theatrical recovery (St) to make up the deficit becomes an expense of the home video revenue stream.

Residuals: The residuals expenses associated with streaming for each film performance probability case is calculated using Equation 49.

$$\begin{matrix}Equation 49 : Calculating streaming video residuals & \\ {S}_{r} = s ( {V}_{c} + {P}_{c} ) . & \end{matrix}$$

Where:
   Sᵣ=The residuals expenses for a given case.
   V_{c}=Combined VOD, SVOD, and AdVOD gross revenue for a given film probability case (c) of Bomb, Low, Expected, High, or Hit.
   P_{c}=Combined Pay TV, PPV, and Free TV gross revenue for a given film probability case (c) of Bomb, Low, Expected, High, or Hit.
   s=An adaptable constant.

Streaming Subtotal: The streaming subtotal revenue calculation is calculated using Equation 50.

$$\begin{matrix}Equation 50 : streaming video sub - total & \\ {S}_{c} = ( {V}_{c} + {P}_{c} ) - {S}_{d} - {S}_{p} - {S}_{t} - {S}_{r} . & \end{matrix}$$

Where:
   Sₜ=Streaming video sub-total for a film probability case (c) of Bomb, Low, Expected, High, or HIL
   Vₜ=Combined VOD, SYOD, and AdVOD gross revenue for a given film probability case (c) of Bomb, Low, Expected, High, or Hit
   P_{c}=Combined Pay TV, PPV, and Free TV gross revenue for a given film probability case (c) of Bomb, Low, Expected, High, or Hit.
   S_{d}=The distribution fees for a given case.
   Sₜ=The theatrical recovery for a given case.
Sᵣ=The residuals for a given case.

GRAND TOTAL: The grand total revenue calculation for each film probability case (c) is calculated using Equation 51.

$$\begin{matrix}Equation 51 : Grand total revenue calculation & \\ {G}_{c} = {R}_{c} + {F}_{c} + {H}_{c} + {S}_{c} . & \end{matrix}$$

Where:
   G_{c}=Grand total net revenue for a given film probability case (c) of Bomb, Low, Expected, High, or Hit.
   Rₜ=Theatrical sub-total for a given film probability case (c).
   F_{c}=Foreign sales less presold for a given case (c).
   Hᵥ=Home video gross sales for a given case.
   Sₜ=Streaming video sub-total for a given film probability case (c)

The revenue forecasting unit (308) includes sub-system outputs that include the primary two user presentation layer outputs of this subsystem are Results-Revenue and Results-Casting, each of which will be discussed below.

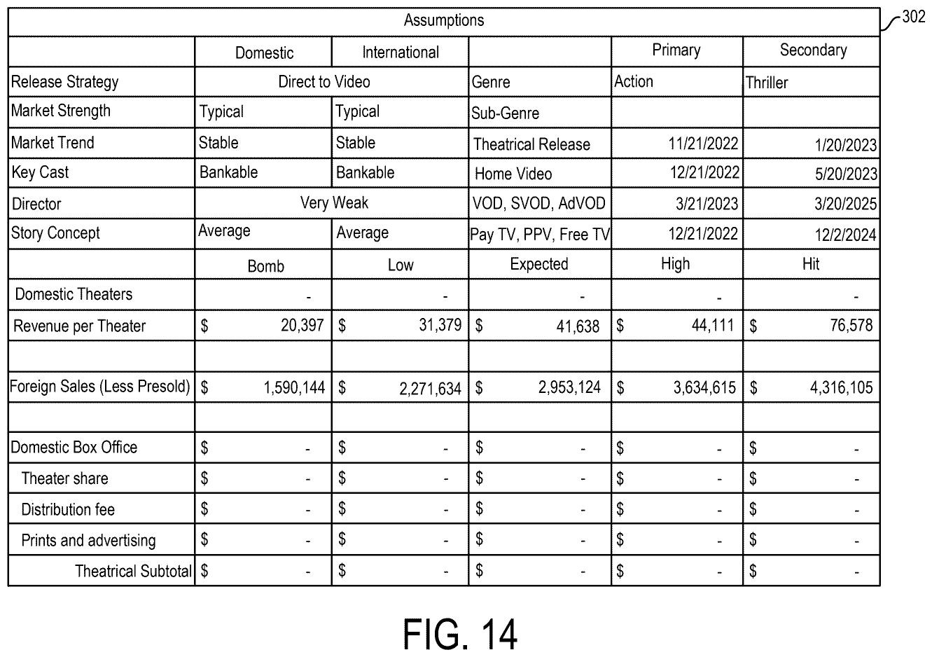

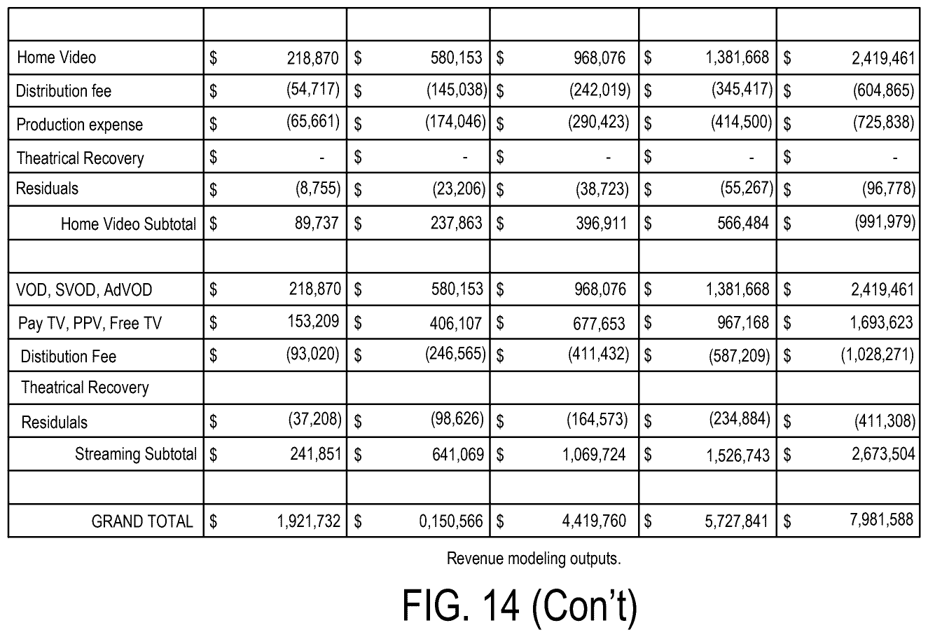

The Results-Revenue as shown in FIG. 14, the various calculation outputs are displayed for each of the five modeled film probability cases of Bomb, Low, Expected, High, or Hit. In addition, the expected release window for each of the film market segments is calculated and displayed. These dates will be used by the investor waterfall sub-system as part of the cash flow analysis.

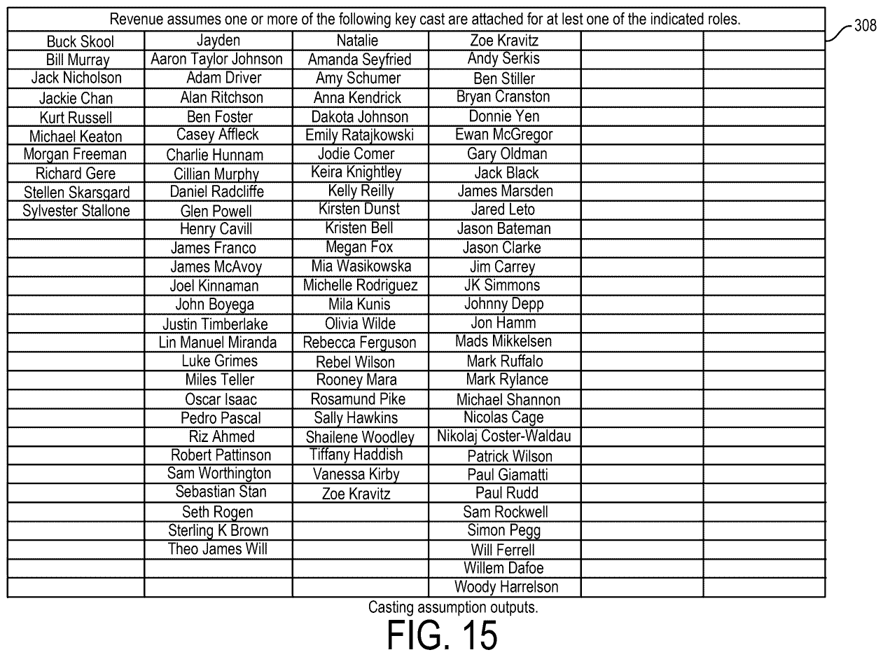

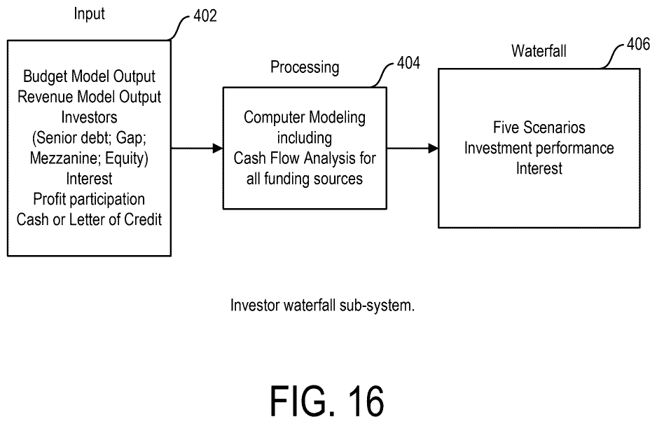

The Results-Casting includes revenue forecasts which are based on having at least one of the film's roles cast to an actor of a specified value to the market. For each role in the film, the system looks at the required sex and age range for that role along with he assumed market value used within the projections, and based on this generates a list of candidate actors for each role of the required sex, approximate age, and market value. The resultant casting list is as shown in FIG. 15. Three points must be emphasized:

No attempt is made to determine acting suitability for a role, so for example, an actor that specializes in comedy roles would not be excluded from a horror role. When casting the film, only a budget sub-system specified number of the identified individuals needs to be cast for the film. Not one per role. Casting someone for a role that has a higher market value than the indicated actors would be expected to generate higher revenue than forecast. There is therefore that potential opportunity to cast someone into a role that brings more value than expected, and hence, improves the revenue outlook of the film.

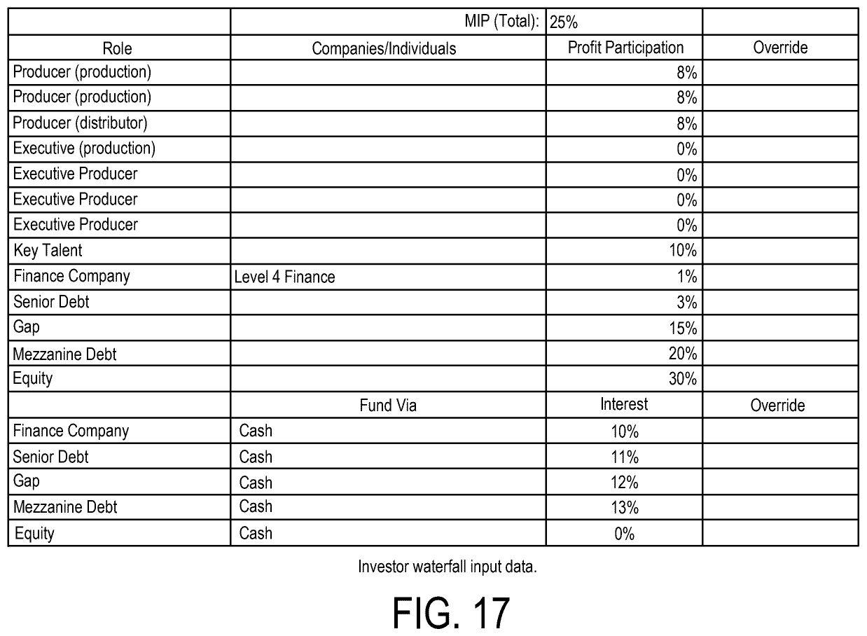

The system (100) includes an investment modeling sub-system (400), or the Investor Waterfall Sub-System as shown in FIG. 17. The investor waterfall subsystem (400) is responsible for computing the investment requirements, and returns on that investment, for the various film probability cases (Bomb, Low, Expected, High, or Hit.). A significant aspect of these calculations involves modeling the project cash flow and determining the anticipated investor interest payments for each scenario. For this sub-system, investors are divided into four categories, with decreasing collateralization and repayment priority: Senior Debt; Gap financing; Mezzanine financing; and Equity.

In addition, the sub-system includes the capability to model two types of investor participation. In the first, traditional approach the investors provided the needed funds as they are required to support film development. In the second, the investors provide a letter of credit guarantee of funds, and the actual funds are then provided by a third-party financial provider. This approach offers the advantage that investors do not need to liquidate assets to invest in the film, but at the added cost of additional financial transactional costs.

The investment modeling sub-system (400) includes an investment input unit (402) includes investment requirement (input data) in addition to input received from other the system's sub-systems, the investor waterfall subsystem received input using the user presentation layer shown in FIG. 17. The inputs consist of the assumed total Movie Incentive Program (MIP) from all sources; the names of the companies and/or individuals that will be investing, if known, the profit participation for each investor or investor category, the interest on capital invested for each category of investor; and whether the investment will be via cash or a letter-of-credit/guarantee for each investor category.

The investment modeling sub-system (400) includes an investment processing unit (404) computer modeling application. The investor waterfall modeling sub-process performs a monthly cash flow analysis from the date of initial investment through the final payment of up-front fees for areas such as streaming. Long-term residuals are not modeled, representing an opportunity for potential but uncertain investor return beyond the forecasts.

The process begins by analyzing cash-out, using data from the other subsystems. For each category of required funding, it receives as input the amount of expenditures and the expected start and end date of funding requirements. For all expenditures, deferred compensation is tracked for potential subsequent payment, but not included as part of the required funding. That data is then used to model the monthly cash-out. Examples of categories of funding are: Total Above-The-Line; Total Production; Total Post-Production; Total G&A; Contingency; Financing Fees; and Completion Bond Fee.

If financing via a loan guarantee is used by any of the investors, the system also model the amount of funding draw from the supporting financial institution, and the subsequent monthly interest due on those draws. The process continues by modeling fixed cash-in in the form of MIP and foreign pre-sales, again using data from other sub-models but modeling the timing of those receipts in this sub-model.

The process continues by modeling the timing of cash receipts from the investor categories, with the assumption that initial funding comes from Senior Debt and Equity investment, followed by Gap, and then by Mezzanine.

The process continues by analysis of cash flow for each film probability case (Bomb, Low, Expected, High, or Hit) and each investor category, looking initially at recoupment of investment and payment of interest only. This modeling consists of a month-by-month analysis of: Cash out from this investor category; Interest earned on outstanding cash; Interest paid; Principle recouped; Cumulative interest paid; and Cumulative investment outstanding.

In performing this calculation, the investors are prioritized as Senior Debt, Gap, Mezzanine Debt, and Equity. For cases in which the film recoups the investor principle and pays the investor interest, the remaining funds are then used to pay deferred compensation. Funds that are available after paying deferred compensation (profits) are then allocated to the various investors using the specified profit participation percentages.

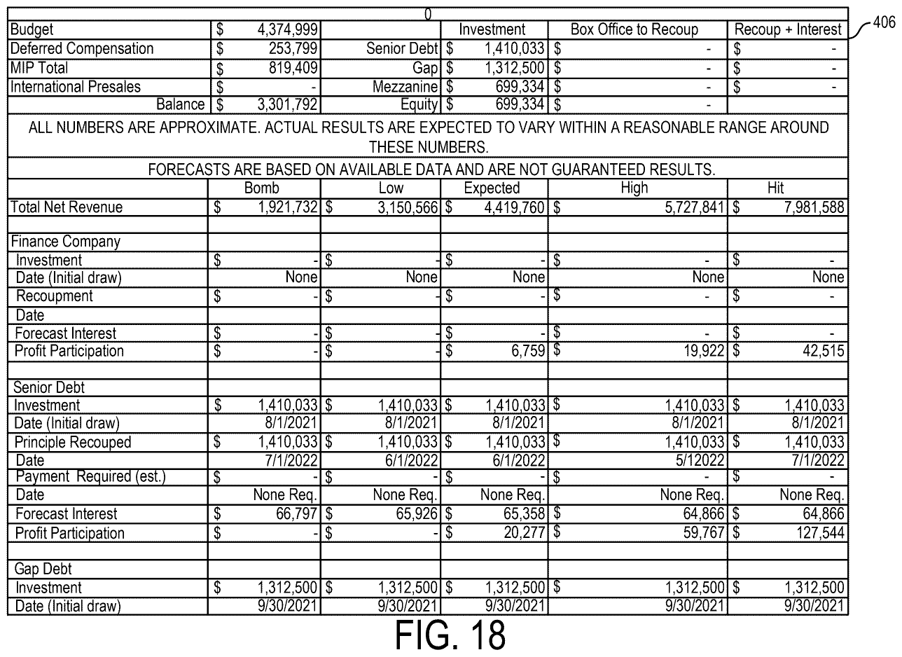

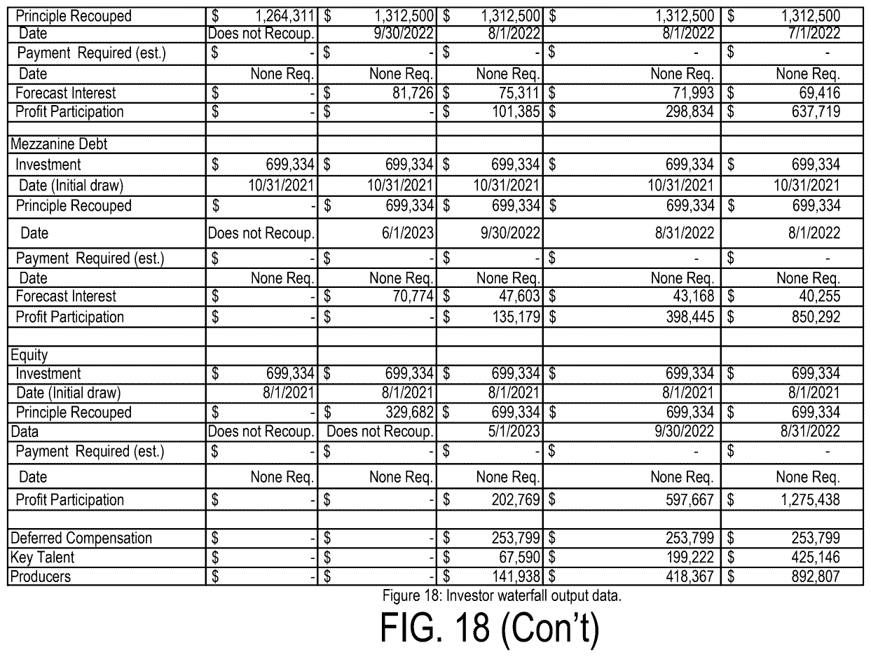

The investment modeling sub-system (400) includes investor waterfall unit (406) for generating an investor waterfall output or the Sub-System Outputs. FIG. 18 shows a representative user interface layer output from the investor waterfall subsystem. At the top, the film budget and the amount of investment obtained in the form of deferred compensation, MIP, and international pre-sales is shown. The net is then the amount that must be funded through investment. The anticipated investor raise for each of senior debt, gap financing, mezzanine financing, and equity is shown.

For each category of investor and each film probability case, the investor waterfall unit (406) displays: The amount of investment required; the date of the initial draw; the forecast amount of principle recoupment; the forecast date at which all principle will be recouped; the forecast interest payments; and the forecast profit participation.

If an investor category is participating using a credit guarantee, the forecast amount of actual payment/funding that will be required is shown, and the forecast date that the funds will be needed is shown. In addition, the forecast amount of paid deferred compensation, key talent profit participation, and producer profit participation is shown.

### Appendix A: List of Equation Variables

TABLE 1
List of acronyms

| .Variable | Description | Used in equations |
|---|---|---|
| $d | The daily cost per BTL | 22 |
| | traveler. | |
| $t | The air transportation | 22 |
| | and transfers cost per | |
| | BTL trip. | |
| % | The percentage of the | 3, 4 |
| | variable ODC or | |
| | variable labor budget. | |
| % f | The total % fee charged | 8 |
| | for other costs (e.g., | |
| | contingency, finance | |
| | fees, completion bond | |
| | fees). | |
| A1 | A parameter that | 27, 29, 32 |
| | varies based on the | |
| | selected release | |
| | strategy. | |
| A2 | A parameter that | 27, 29, 32 |
| | varies based on the | |
| | selected market | |
| | strength. | |
| A3 | A parameter that | 27, 29, 32 |
| | varies based on the | |
| | selected market trend. | |
| A4 | A parameter that | 27, 29, 32 |
| | varies based on the | |
| | selected key cast value | |
| | to the selected market. | |
| A5 | A parameter that | 27, 29, 32 |
| | varies based on the | |
| | selected director value | |
| | to the selected market. | |
| A6 | A parameter that | 27, 29, 32 |
| | varies based on the | |
| | selected story concept | |
| | value to the selected | |
| | market. | |
| A7 | A parameter that | 27, 28 |
| | varies based on the film | |
| | genre adjustment for | |
| | the international | |
| | market. | |
| Ak | The following set of | 27, 29, 32 |
| | configurable and | |
| | adaptable constants | |
| | adjusted as part of | |
| | machine learning. | |
| ARn | The revenue | 24 |
| | adjustment for a given | |
| | sub-genre n, expressed | |
| | as a percentage. | |
| ARp | The revenue | 26 |
| | adjustment for a given | |
| | genre p, expressed as a | |
| | percentage. | |
| aTn | The Theater | 23 |
| | adjustment for a given | |
| | sub-genre n, expressed | |
| | as a percentage. | |
| ATp | The Theater | 25 |
| | adjustment for a given | |
| | genre p, expressed as a | |
| | percentage. | |
| B | The film target budget. | 2, 6, 8, 9, 12, 20, 21, 27 |
| B % p | The adaptable and | 13 |
| | normalized labor | |
| | budget percentage by | |
| | phase for non-fixed | |
| | price labor (normalized | |
| | to 100%). | |
| B_{f} | The calculated budget | 29, 32 |
| | for this film from the | |
| | budget calculation sub- | |
| | system. | |
| Bₘ | Film budget in millions | 1, 11 |
| | of dollars. | |
| Bₙₚ | The variable labor | 14, 15 |
| | budget, by phase, for | |
| | each budget line item. | |
| Bₒ | The ODC variable or | 3, 4 |
| | labor variable budget. | |
| Bₜ | The typical budget for | 29, 32 |
| | this genre of film, from | |
| | Config_Comps. | |
| BTL$ₕ | The BTL travel budget | 20 |
| | top of range. | |
| BTL$ₗ | The BTL travel budget | 21 |
| | bottom of range. | |
| C | The adjustment for one- | 11, 27, 29, 32 |
| | time exceptional | |
| | situations (e.g., Covid). | |
| Cast | Total cast days, | 19 |
| | excluding extras, from | |
| | Calc_Project. | |
| CS | The crew size in full- | 11 |
| | time equivalents. | |
| Cₜ | The cost per BTL | 22 |
| | Traveler | |
| D | An adaptable | 11, 29 |
| | distribution constant | |
| | that varies based on | |
| | the distribution | |
| | approach. | |
| D %ₚ | The phase percentage | 13 |
| | of total days, from | |
| | Calc_Project. | |
| Days | The number of days | 22 |
| | spent in a travel | |
| | capacity from Equation | |
| | 18. | |
| Daysₚ | The total days allocated | 18 |
| | for each phase of work | |
| | (p). | |
| D_{c} | The forecast domestic | 36, 37, 40 |
| | box office for a given | |
| | case. | |
| D_{ce} | Equivalent domestic | 41, 46, 47 |
| | box office gross sales for | |
| | a given case. For films | |
| | with a theatrical | |
| | release, this will be the | |
| | forecast domestic box | |
| | office gross sales, | |
| | however for films with | |
| | a day-and-date or | |
| | streaming only release, | |
| | this value will be the | |
| | forecast of what the | |
| | domestic box office | |
| | would have been if the | |
| | film had A theatrical | |
| | release. | |
| D_{d} | The distribution fees | 38, 40 |
| | for a given case. | |
| Dₚ | The prints and | 39, 40 |
| | advertising fees for a | |
| | given case. | |
| Dₜ | The theater share of | 37, 38, 40 |
| | domestic box office | |
| | gross sales for a given | |
| | case. | |
| Extras | The number of extras | 12 |
| | expressed in person- | |
| | days. | |
| f(B₁, B₂, 1) | A function on the | 32 |
| | current film budget | |
| | (B1); the mean film | |
| | budget for other films | |
| | in this genre, adjusted | |
| | to current year dollars | |
| | (B2); and an adaptable | |
| | constant 1. The function | |
| | ( ) returns B1 for | |
| | amounts up to B2, or | |
| | B1 + 1 * (B1-B2) for | |
| | films with a | |
| | budget over B1. | |
| F_{c} | Foreign sales less | 35, 51 |
| | presold for a given case | |
| | (c). | |
| FLₙ | The fixed price labor | 10 |
| | costs for each budget | |
| | line-item n. | |
| Fₙ | The fixed price ODC | 7 |
| | cost for each budget | |
| | line-item n. | |
| FTDₙₗₚ | A three-dimensional | 15 |
| | matrix of the number of | |
| | full-time person-days | |
| | for each Budget line | |
| | item, each labor | |
| | category, and each | |
| | phase. | |
| g | The film genre | 12, 29, 30, 32, 33 |
| | adjustment. | |
| G_{c} | Grand total net | 51 |
| | revenue for a given film | |
| | probability case (c) of | |
| | Bomb, Low, Expected, | |
| | High, or Hit. | |
| gₚ and gₛ | The genre adjustments | 28, 30, 33 |
| | for the primary (p) and | |
| | secondary (s) genres of | |
| | the film. | |
| g_{sub} | The sub-genre | 30, 33 |
| | adjustment if a sub- | |
| | genre is specified. | |
| H_{c} | Home video gross | 41, 42, 43, 44, 45 |
| | revenue for a given film | |
| | probability case (c) of | |
| | Bomb, Low, Expected, | |
| | High, or Hit. | |
| H_{d} | The distribution fees | 42, 45 |
| | for a given case. | |
| Hₚ | The production | 43, 45 |
| | expenses for a given | |
| | case. | |
| Hᵣ | The residuals expenses | 44, 45 |
| | for a given case. | |
| Hₜ | The theatrical recovery | 45 |
| | for a given case. | |
| Hᵥ | Home video sub-total | 45, 51 |
| | for a given film | |
| | probability case (c) of | |
| | Bomb, Low, Expected, | |
| | High, or Hit. | |
| k | An adaptable constant. | 19, 37, 41 |
| Key | Number of key cast, | 19 |
| | from Calc_Project. | |
| kₙₚ | An adaptable Travel | 18 |
| | constant multiple | |
| | specific to each | |
| | category of staff (n) and | |
| | each phase of work (p), | |
| | where the phases of | |
| | work are prep, shoot, | |
| | and post. | |
| kₚ | An adaptive genre | 25, 26 |
| | specific constant that is | |
| | used to adjust for | |
| | external factors such as | |
| | popularity trends. | |
| l | An adaptable constant. | 38, 42 |
| L$ₗₚ | The labor category day | 15 |
| | rate for each phase, as | |
| | computed within | |
| | Calc_LBU. | |
| L$ₙ | The total variable labor | 14 |
| | budget for each | |
| | budgetary line item, as | |
| | computed within | |
| | Calc_Budget. | |
| L$ₙₗₚ | The percentage of labor | 15 |
| | allocation for each | |
| | budgetary line item, | |
| | each labor category, | |
| | and each phase, as | |
| | computed within | |
| | Calc_LBU. | |
| Lₜ | The total labor target. | 9, 10 |
| Lᵥ | The variable labor | 10 |
| | target. | |
| m | An adaptable constant. | 27, 29, 32, 39, 43 |
| n | An adaptable constant. | 44 |
| NTₚ | The normalized phase | 14 |
| | variable labor | |
| | percentage. | |
| O₁-O₂ | Polynomial coefficients. | 3, 21 |
| O₁-O₃ | Polynomial coefficients. | 4, 6, 12 |
| O₁-O₄ | Polynomial coefficients. | 2, 20 |
| ODC_{f} | The fixed price ODC | 7 |
| | target. | |
| ODCₒ | The ODC-other target. | 8 |
| ODCₜ | The total ODC budget | 9 |
| | (fixed, variable, plus | |
| | other). | |
| ODCᵥ | The variable ODC | 2, 6 |
| | target. | |
| Oₙ | The ODC adjustment | 7 |
| | for each budget line- | |
| | item n. | |
| p | An adaptable constant. | 47 |
| p₁ and p₂ | Weighting constants | 28, 30, 33 |
| | that total to 1.0 (100%). | |
| P_{c} | Combined Pay TV, | 47, 48, 49, 50 |
| | PPV, and Free TV gross | |
| | revenue for a given film | |
| | probability case (c) of | |
| | Bomb, Low, Expected, | |
| | High, or Hit. | |
| r | An adaptable constant. | 48 |
| R_{c} | Theatrical sub-total for | 34, 36, 40, 51 |
| | a given film probability | |
| | case (c). | |
| Rₑ | The revenue per | 34 |
| | theater, in current year | |
| | dollars, for the expected | |
| | case. | |
| Rₑᵥₙ | The current year | 26 |
| | adjusted revenue for | |
| | each film n within this | |
| | genre. | |
| R_{f} | The candidate foreign | 27 |
| | revenue, in dollars. | |
| R_{g} | The average revenue | 26 |
| | for each genre p. | |
| Rᵢ | For the foreign | 35 |
| | territories that have | |
| | not been presold, the | |
| | expected foreign sales | |
| | of that case for a given | |
| | territory (i) of the n | |
| | foreign territories, as | |
| | computed within | |
| | Calc_ForeignSales and | |
| | described previously. | |
| Rₙ | The average revenue | 24 |
| | for films of this sub- | |
| | genre. | |
| S | An adaptable constant. | 1, 11, 49 |
| S %ₚ | The adaptable and | 13 |
| | normalized phase | |
| | percentage of staffing | |
| | by phase (normalized to | |
| | 100%). | |
| S_{c} | Streaming video sub- | 50, 51 |
| | total for a given film | |
| | probability case (c) | |
| S_{d} | the distribution fees for | 48, 50 |
| | A given case. | |
| Sᵣ | The residuals for a | 49, 50 |
| | given case. | |
| Sₜ | The theatrical recovery | 50 |
| | for a given case. | |
| T | The number of trips per | 22 |
| | BTL traveler. | |
| Tₐ | Coefficient, | 1 |
| | representing default | |
| | days per $M budget. | |
| T_{b} | Exponent, representing | 1 |
| | economies and | |
| | diseconomies of scale. | |
| T_{c} | The number of theaters | 31, 36, 39 |
| | for a given case. | |
| TDₙ | Travel days for a given | 18 |
| | category of staff (ATL, | |
| | BTL, or Crew), n. | |
| Tₑ | The expected number of | 29, 31, 32 |
| | domestic Theaters, | |
| | from Equation 29. | |
| T_{f} | Power function | 1 |
| | constant. | |
| T_{g} | The average number of | 25 |
| | theaters for each genre | |
| | g. | |
| Tₘ | The mean theaters | 29, 32 |
| | from Config_Comps | |
| | benchmark data. | |
| Tₙ | The number of | 23, 25 |
| | Theaters for each film n | |
| | within this genre. | |
| Tₚ | Total (combined) phase | 13 |
| | percentage, with p | |
| | corresponding to the | |
| | prep, shoot, and wrap | |
| | phases. | |
| Tᵣ | The expected revenue | 32 |
| | per domestic Theater. | |
| Trav | Cast travelers. | 19 |
| v | An adaptable constant. | 46 |
| V_{c} | Combined VOD, SVOD, | 46, 48, 49, 50 |
| | and AdVOD gross | |
| | revenue for a given film | |
| | probability case (c) of | |
| | Bomb, Low, Expected, | |
| | High, or Hit. | |
| ΔR %ₙ | The historic revenue | 34 |
| | per theater for the | |
| | alternate scenario n, | |
| | expressed as a | |
| | percentage of Re. | |
| ΔT %ₙ | The historic number of | 31 |
| | theaters for the | |
| | alternate scenario n, | |
| | expressed as a | |
| | percentage of a | |
| | percentage of Te. | |

APENDIX-B Acronyms
AdVOD: Ad supported VOD.
AI: Artificial Intelligence.
ATL: Above-the-Line.
BTL: Below-the-Line.
DGA: Director's Guild of America.
FTD: Full-Time-Day.
FTE: Full-Time Equivalent.
G&A: General and Administrative.
H&W&P: Health, Welfare, and Pension.
IATSE: International Alliance of Theatrical Stage Employees.
IBT: International Brotherhood of Teamsters.
MIP: Movie Incentive Program.
OA: Office Automation.
ODC: Other-direct-charge.
PA: Production Assistant.
PPV: Pay Per View.
SAG: Screen Actors Guild.
STN: Subject to Negotiation.
SVOD: Streaming VOD.
VBA: Visual Basic for Applications.
VOD: Video On Demand.
WGA: Writer's Guild of America.
XML: extended Markup Language.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. An Artificial Intelligence (AI) based forecasting system for entertainment industry project budgets, revenue, and investor waterfalls, wherein the resource estimation system comprising:
a resource acquisition module, wherein the resource acquisition module includes:
a budget modeling sub-system, wherein the budget modeling sub-system includes:
a budget input unit for receiving a budget input;
a budget processing unit for generating an optimized film budget based on benchmark data derived from a historical project data, a plurality of templates and the budget input;
a scheduling unit for generating production schedules based on the optimized film budget;
a budgeting unit for receiving optimized film budget including line-item budget, labor charges, direct charge,
travel budget, cash flow and manual adjustment overrides to provide a budget output; and
a budget output unit for generating the budget output including a final budget breakdown and a final production schedule;
a revenue modeling sub-system, wherein the revenue modeling module includes:
a revenue input unit for receiving a revenue data based on film distribution and foreign sales;
a revenue processing unit for receiving the revenue data and applying adaptable configuration and compiling historic data from previous films for generating a combined revenue; and
a revenue forecasting unit for generating a revenue forecast and performing cash-flow analysis based on the combined revenue; and
an investment modeling sub-system for computing investment requirements and return on investment (ROI), wherein the investor modeling sub-system includes:
an investment input unit for receiving investment requirements based on the budget output, the revenue forecast and details of investors;
an investment processing unit for receiving the investment requirements and performing a cash flow analysis for prioritizing the investors within one or more categories; and
an investor waterfall unit for generating an investor waterfall output including an anticipated investor raise for each of the one or more categories based on the cash flow analysis for a number of film probability case; and
a resource combining module, wherein the resource combining module allows interaction of the budget modeling module, the revenue modeling sub-system and the investment modeling sub-system to combine the final budget breakdown, the final production schedule, the revenue forecast, the cash-flow analysis, and the investor waterfall output for estimating resources for the film.

2. The system in accordance with claim 1, wherein the budget input, the revenue input and the investment requirements include a combination of textual input and a dropdown list, further wherein the dropdown list includes film industry specific selection values.

3. The system in accordance with claim 2, wherein the dropdown list is based on genre, period, target budget of the specific selection values.

4. The system in accordance with claim 1, wherein the historic project data and the plurality of templates represent parameterized configuration data for supporting learning overtime based on adjustment initiated from observed actual and a set of rules for supporting model adjustment based on film specific input data.

5. The system in accordance with claim 1, wherein the historic project data includes g-power function shaping parameters, polynomial equation shaping parameters, budget line-item benchmark data, genre specific adjustment data, and period specific adjustment data.

6. The system in accordance with claim 5, wherein the power function shaping parameters are used to calculate film shoot days through using an equation
$$S = {T}_{f} + T a B {m}^{T b}$$
wherein the S represents number of shoot days, T_{f} represents power function constant, Ta represents coefficient including default days per $M budget, Bm represents film budget in millions of dollars and Tb represents exponent including economies and diseconomies of scale.

7. The system in accordance with claim 1, wherein the polynomial equation shaping parameters for computing other direct charges (ODCs) including a fixed ODCs and a variable ODCs, further wherein the variable ODCs are computed using an equation
$$ODCv = {O}_{1} + {O}_{2} {B}^{1} + {O}_{3} {B}^{2} + {O}_{4} {B}^{3}$$
wherein the ODCv represents the variable ODCs, O₁ to O₄ represents polynomial coefficient and B represents the budget of the film.

8. The system in accordance with claim 1, wherein budget line-item benchmark data for computing a budget line-item baseline, further wherein the budget line-item baseline using configuration data including a budget, production, post-production, general and administrative budget, fixed-line ODCs percentage, Variable-line ODCs percentage, and a labor percentage.

9. The system in accordance with claim 8, wherein the Variable-line ODCs percentage and the labor percentage are calculated using a budget line-item specific threshold budget.

10. The system in accordance with claim 9, wherein the Variable-line ODCs percentage and the labor percentage is calculated if the budget line-item specific threshold budget is less than a threshold, further wherein the Variable-line ODCs percentage and the labor percentage is derived using an equation
$$\% = {O}_{1} + ( {O}_{2} * {B}_{0} ) ,$$
wherein, % represents percentage of the variable ODC or variable labor budget.
O₁ through O₂ are polynomial coefficients.
Bo=ODC variable or labor variable budget.

11. The system in accordance with claim 9, wherein the Variable-line ODCs percentage and the labor percentage is calculated if the budget line-item specific threshold budget is more than a threshold, further wherein the Variable-line ODCs percentage and the labor percentage is derived using an equation
$$\begin{matrix}Equation 4 : Budget \% for higher than threshold films & \\ \% = {O}_{1} + ( {O}_{2} * {B}_{o} ) + ( {O}_{3} * {B}_{o}^{2} ) . & \end{matrix}$$
Where:
%=the percentage of the variable ODC or variable labor budget.
O₁ through O₂ are polynomial coefficients.
Bₒ=The ODC variable or labor variable budget.

12. The system in accordance with claim 1, wherein the budget processing unit uses a dynamic modeling to provide a constraint optimized budget that is near the target budget, further wherein the constraints are derived from the historic project data and templates and rules embedded within a series of sub-models, further wherein the series of sub-models includes a Calc_LBU, a Calc_Project, a Calc_Crew and a Calc_budget.

13. The system in accordance with claim 12, wherein the Calc_LBU is used for labor build-ups for film industry union contracts to compute a fully loaded rate using an equation
$$Rate = Direct + Fringe + H \& W \& P$$
wherein rates for fringe and H&W&P are defined within the specific union contracts.

14. The system in accordance with claim 1, wherein the Calc_Project is used to calculate and assemble a project summary data, further wherein the project summary data includes a film production days, prep days, shoot days, stunt days, wrap days, post days, a crew size required, optimum number of key-cast, expected number of person days for extras, a labor budget, contingency fees, finance fees, and completion bond fee, and shoot day allocations.

15. The system in accordance with claim 14, wherein the labor budget is categorized into a variable ODC target, further wherein the variable ODC target is computed using an equation
$${ODC}_{v} = {O}_{1} + ( {O}_{2} * B ) + ( {O}_{3} * {B}^{2} )$$
wherein the
ODCᵥ=The variable ODC target.
O₁ through O₃ are polynomial coefficients.
B=The film target budget.

16. The system in accordance with claim 14, wherein the labor budget is categorized into a fixed price ODC calculation, further wherein the fixed price ODC calculation is computed using an equation
$${ODC}_{f} = {\sum }_{i = 0}^{n} {F}_{n} * {O}_{n}$$
wherein the
ODC_{f}=The fixed price ODC target.
Fₙ=The fixed price ODC cost for each budget line-item n.
Oₙ=The ODC adjustment for each budget line-item n.

17. The system in accordance with claim 14, wherein the labor budget is categorized into an other ODCs target, further wherein the other ODCs target is computed using an equation
$${ODC}_{o} = \frac{B}{( 1 + \% )} * {\%}_{f}$$
wherein the
ODCₒ=The ODC-other target.
B=The film target budget.
%_{f}=The total % fee charged for other costs (e.g., contingency, finance fees, completion bond fees).

18. The system in accordance with claim 14, wherein the labor budget is categorized into a labor target budget, further wherein the labor target budget is computed using an equation
$${L}_{t} = B - {ODC}_{t}$$
wherein the
Lₜ=The total labor target.
B=The film target budget.
ODCₜ=The total ODO budget (fixed, variable, plus other).

19. The system in accordance with claim 14, wherein the labor budget is categorized into a variable labor target, further wherein the variable labor target is computed using an equation
$${L}_{v} = {L}_{t} - {\sum }_{i = 0}^{n} {FL}_{n}$$
wherein the
Lᵥ=The variable labor target.
Lₜ=The total labor target.
FLₙ=The fixed price labor costs for each budget line-item n.

20. The system in accordance with claim 14, wherein the crew size is computed using an equation
$$CS = c + ( d * S * {B}_{m} )$$
wherein the
CS=The crew size in full-time equivalents.
c=A constant that adapts with learning.
d=A constant that adapts with learning.
S=Shoot days.
Bₘ=Film budget in millions of dollars.

21. The system in accordance with claim 14, wherein the expected number of person days for extras is computed using an equation
$$Extras = ( {O}_{1} + ( {O}_{2} * B ) + ( {O}_{3} * {B}^{2} ) ) * g$$
wherein the
Extras=The number of extras, expressed in person-days.
O₁ through O₃ are polynomial coefficients.
B=The film target budget.
g=A genre specific adjustment.

22. The system in accordance with claim 1, wherein the Calc_crew is used to determine a film production phase line staffing, a staff category, and labor costs.

23. The system in accordance with claim 22, wherein the film production phase line staffing includes a staffing and a target budget for prep, shoot, and cast, further wherein the staffing is determined by using a first set of adaptable proportionality constants to generate a normalized phase staffing percentage and the target budget is determined by using a second set of adaptable proportionality constants to generate a phase normalized labor budget percentage and further combining the normalized phase staffing percentage and the phase normalized labor budget percentage to generate a normalized phase percentage
$${T}_{p} = D {\%}_{p} * S {\%}_{p} * B {\%}_{p}$$
wherein the
Tₚ=Total (combined) phase percentage, with p corresponding to the prep, shoot, and wrap phases.
D %ₚ=The phase percentage of total days, from Calc_Project.
S %ₚ=The adaptable and normalized phase percentage of staffing by phase (normalized to 100%).
B %ᵥ=The adaptable and normalized labor budget percentage by phase for non-fixed price labor (normalized to 100%).

24. The system in accordance with claim 23, wherein the normalized phase used to compute a variable labor budget for each phase of work for each budget line item using Equation
$${B}_{np} = {NT}_{p} * L {\$}_{n}$$
wherein the
Bₙₚ=The variable labor budget, by phase, for each budget line item.
NTₚ=The normalized phase variable labor percentage.
L$ₙ=The total variable labor budget for each budgetary line item, as computed within Calc_Budget.

25. The system in accordance with claim 24, wherein number of FTDs (Fulltime person day calculation) for each labor category, each phase and each budget line item is computed using an equation
$$FTD = \frac{{B}_{np} * L {\%}_{nlp}}{L {\$}_{lp}}$$
wherein the
FTDₙₗₚ=A three-dimensional matrix of the number of full-time person-days for each budget line item, each labor category, and each phase.
Bₙₚ=The variable labor budget, by phase, for each budget line item.
L %ₙₗₚ=The percentage of labor allocation for each budgetary line item, each labor category, and each phase, as computed within Cale_LBU.
L$ₗₚ=The labor category day rate for each phase, as computed within Calc_LBU.

26. The system in accordance with claim 25, wherein a number of total FTD by phase is computed by summing FTD across all budget line items and all labor categories for each phase using an equation
$${FTD}_{p} = {\sum }_{i = 0}^{n} {\sum }_{0}^{l} {FTD}_{nl}$$

27. The system in accordance with claim 26, wherein a number of crew size (FTE) for each phase (FTEp) is computed by dividing the FTDp by a duration of phase (Dp) using an equation
$${FTE}_{p} = \frac{{FTD}_{p}}{{D}_{p}}$$

28. The system in accordance with claim 1, wherein a travel ODCs (Calc_ODC_Travel) is computed for Above-the-Line (ATL), Below-the-Line (BTL), and cast for each category of staff and each phase of work is computed by using an equation
$${TD}_{n} = {k}_{np} {Days}_{p}$$
wherein the
TDₙ=Travel days for a given category of staff (ATL, BTL, or Crew), n.
kₙₚ=An adaptable travel constant multiple specific to each category of staff (n) and each phase of work (p), where the phases of work are prep, shoot, and post.
Daysₚ=The total days allocated for each phase of work (p).

29. The system in accordance with claim 28, wherein a cast traveler quantity is computed using an equation
$$Trav = Key + ( k * Cast )$$
wherein the
Trav=Cast travelers.
Key=Number of key cast, from Calc_Project.
k=A film budget specific constant, using a step function.
Cast=Total cast days, excluding extras, from Calc_Project.

30. The system in accordance with claim 28, wherein a high value BTL traveler quantity is computed using an equation
$$BTL {\$}_{h} = {O}_{1} + ( {O}_{2} * B ) + ( {O}_{3} * {B}^{2} ) + ( {O}_{4} * {B}^{3} )$$
wherein the
BTL$ₕ=The BTL travel budget top of range.
O₁ through O₄ are polynomial coefficients.
B=The film target budget.

31. The system in accordance with claim 28, wherein a low value BTL traveler quantity is computed using an equation
$$BTL {\$}_{l} = {O}_{1} + ( {O}_{2} * B )$$
wherein the
BTL$ₗ=the BTL travel budget bottom of range.
O₁ through O₂ are polynomial coefficients.
B=The film target budget.

32. The system in accordance with claim 28, wherein a cost per BTL traveler (Ct) using an equation
$${C}_{t} = ( T * {\$}_{t} ) + ( Days * {\$}_{d} )$$
wherein the
Cₜ=The cost per BTL traveler,
T=The number of trips per BTL traveler,
$ₜ=The air transportation and transfers cost per BTL trip,
Days=The number of days spent in a travel capacity from Equation 18,
$_{d}=The daily cost per BTL traveler.

33. The system in accordance with claim 1, wherein the scheduling unit includes a manual override for allowing a user to manually override the target budget, travel related expenses and a budget override, further wherein the manual override replaces the calculated values and re-runs internal calculations to create the target budget.

34. The system in accordance with claim 1, wherein the budget output displays a final project schedule, a budget summary and budget line items.

35. The system in accordance with claim 1, wherein the system uses extended Markup Language (XML) files with an .mmbx extension to transfer data to Movie Magic budgeting software.

36. The system in accordance with claim 1, wherein the revenue input includes the budget output, a primary revenue, a foreign sale and a revenue forecast configuration data, further wherein the revenue forecast configuration data includes a Config_ForeignSales, a Config_Comps, a Config_Cast, and a Config_Revenue.

37. The system in accordance with claim 36, wherein the Config_Revenue includes a plurality of adaptable revenue category constants and genre and sub-genre adjusting historic benchmark constants.

38. The system in accordance with claim 37, wherein a sub-genre theater adjustment is computed using equation
$${aT}_{n} = \frac{{T}_{n}}{( \frac{{\sum }_{i = 0}^{n} {T}_{n}}{n} )}$$
wherein the
aTₙ=The Theater adjustment for a given sub-genre n, expressed as a percentage.
Tₙ=The average number of theaters for films of this sub-genre.

39. The system in accordance with claim 37, wherein a sub-genre revenue adjustment is computed using an equation
$${aR}_{n} = \frac{{R}_{n}}{( \frac{{\sum }_{i = 0}^{n} {R}_{n}}{n} )}$$
wherein the
aRₙ=The revenue adjustment for a given sub-genre n, expressed as a percentage.
Rₙ=The average revenue for films of this sub-genre.

40. The system in accordance with claim 1, wherein the revenue processing unit includes:
a Calc_cast module for creating a casting list of potential actors, wherein the casting list of potential actors matches the film casting requirements and further support the revenue forecasts; and
a Calc_foreignsales module for computing a candidate total foreign revenue and further allocates the candidate total foreign revenue to a plurality of foreign territories and supports territory adjustments to arrive at the adjusted total foreign sales and final foreign sales by territory; and
a Calc_Revenue module for calculating revenue and expense values for five different film revenue probability scenarios, wherein the five different film revenue probability scenarios are Bomb, Low, Expected, High, and Hit.

41. The system in accordance with claim 40, wherein the candidate total foreign revenue is computed using an equation
$${R}_{f} = B * C * ( m ( {\prod }_{k = 1}^{n} {A}_{k} ) )$$
wherein the
R_{f}=The candidate foreign revenue, in dollars.
B=The film target budget.
C=The adjustment for one-time exceptional situations (e.g., Covid).
m=An adaptable constant adjusted as part of machine learning.
Aₖ=The following set of configurable and adaptable constants adjusted as part of machine learning.
A₁=A parameter that varies based on the selected release strategy.
A₂=A parameter that varies based on the selected market strength.
A₅=A parameter that varies based on the selected market trend.
A₄=A parameter that varies based on the selected key cast value to the selected market.
A₅=A parameter that varies based on the selected director value to the selected market.
A₅=A parameter that varies based on the selected story concept value to the selected market.
A₇=A parameter that varies based on the film genre adjustment for the international market, calculated using Equation 28.
$${A}_{7} = {p}_{1} {g}_{p} + {p}_{2} {g}_{s}$$
Where:
A₇=The film genre adjustment,
p₁ and p₂=Weighting constants that total to 1.0 (100%),
gₚ and gₛ=The genre adjustments for the primary (p) and secondary(s) genres of the film.

42. The system in accordance with claim 1, wherein the investment input module includes a combination of the budget model output, the revenue model output and a plurality of investor parameters, further wherein the plurality of investor parameters includes a list of assumed total Movie Incentive Program (MIP), a list of companies, a plurality of investor categories, a profit share of an investor, an interest rate, and a mode of receiving investment.

43. The system in accordance with claim 42, wherein the mode of receiving investment is either via cash or a letter of credit or a letter of guarantee form each investor category.

44. The system in accordance with claim 42, wherein the plurality of investor categories includes a senior debt, a Gap, a Mezzanine and equity.

45. The system in accordance with claim 42, wherein the investment input module receives input using user presentation layer.

46. The system in accordance with claim 1, wherein the investor processing unit receives amount of expenditures, expected start date and expected end date of funding requirements, further wherein the expenditures include a deferred compensation used to model the monthly cash-out flow analysis.

47. The system in accordance with claim 1, wherein the anticipated investor raise is provided for a plurality of categories of funding, further wherein the plurality of categories of funding includes a total above-the-line, total production, total post-production, total g&a, a contingency, a financing fees, and a completion bond fee.

48. The system in accordance with claim 1, wherein the plurality of film probability cases is selected from Bomb, Low, Expected, High, or Hit.

49. The system in accordance with claim 1, wherein the investor waterfall output is generated for each category of the plurality of investor categories and each of the plurality of film probability cases, further wherein the investor waterfall output shows a required investment, an initial investment draw date, a principle recoupment forecast amount, a principle recoupment forecast date, an interest payments forecast, a profit participation forecast, a key talent profit participation, paid deferred compensation and producer profit participation.
